(19) United States
(12) Patent Application Publication
(10) Pub. No.: US 2014/0048494 A1
(43) Pub. Date: Feb. 20, 2014

(54) APPARATUS AND METHOD OF CREATING A CONCENTRATED SUPERSATURATED GASEOUS SOLUTION HAVING IONIZATION POTENTIAL

(71) Applicant: Frederick Lee Simmons, JR., Chicago, IL (US)

(72) Inventor: Frederick Lee Simmons, JR., Chicago, IL (US)

(21) Appl. No.: 13/901,581

(22) Filed: May 24, 2013

Related U.S. Application Data
(63) Continuation-in-part of application No. 09/062,757, filed on Apr. 20, 1998, now Pat. No. 6,154,311.
Application No. 09/062,757 is a continuation-in-part of application No. 09/315,593, filed on May 20, 1999, now Pat. No. 6,599,618.
(60) Provisional application No. 61/651,883, filed on May 25, 2012.

(51) Int. Cl. C02F 1/72; B01F 3/04

(52) U.S. Cl. CPC C02F 1/72; B01F 3/04099
USPC 210/748.12; 210/198.1; 210/150; 261/75; 502/350; 502/242

(57) ABSTRACT

The present invention describes an apparatus and method for creating dense nano-multi molecular packing of gaseous molecules concentrated in liquid solutions and the ionization of the resultant dense gaseous nano-multi-molecular molecules forming a concentration of free-radicals saturating liquid solutions without cavitation of nuclei and without bubbles for the dissolution, destruction, disinfection and remediation of biological, chemical and electrochemical threats and contaminants.

### BACKGROUND OF THE INVENTION

The present invention describes an apparatus and method for creating dense nano-multi molecular packing of gaseous molecules concentrated in liquid solutions and the ionization of the resultant dense gaseous nano-multi-molecular molecules forming a concentration of free-radicals saturating liquid solutions without cavitation of nuclei and without bubbles for the dissolution, destruction, disinfection and remediation of biological, chemical and electrochemical threats and contaminants.

The huge expansion of the chemical and petroleum industries in the twentieth century has resulted in the generation of a vast array of chemical products for daily use. According to an estimate, there are somewhere between 8 to 18 million molecular species of natural and man-made species organic compounds present in the biosphere, of which as many as 40,000 is pre-dominant in our daily lives (Hou et al. 2003). Since soil and groundwater are preferred sinks for complex contamination, various chemical and biological soil properties are profoundly altered, which effects biodiversity and soil function. The contaminates include the alkanes, monoaromatics, monocyclic, and polycyclic aromatic compounds, chlorinated hydrocarbons, including the polychlorinated biphenyls, nitroaromatics and nitrogen heterocycles. Often the organic contaminates are present as complex mixtures of different chemical species, as are present in petroleum on sites including petroleum refineries, petrochemical plants, gas stations, leaking storage tanks and exploration and production well-heads. Halogenated chemicals are potentially found in chemical manufacturing plants or disposal areas, pesticide/herbicide mixing areas, contaminated marine sediments, fire fighting training areas, vehicle maintenance areas, landfills and burial pits, and oxidation ponds/lagoons. Explosive contaminates such as TNT, DNT, RDX and other nitroaromatics may be found on sites like artillery/impact areas, contaminated marine sediments, disposal wells, landfills and burial pits, and TNT washout lagoons. Sites contaminated by heavy metals include battery disposal areas, burn pits, chemical disposal areas, contaminated marine sediments, electroplating/metal finishing shops. Excessive levels of inorganic fertilizer-related chemicals introduced into soil, such as ammonia, nitrates, phosphates, and phosphonates, pharmaceuticals such as estrogens and antibiotics, and harmful bacteria such as salmonella, E-coli and Listeriosis which accumulate and lead to contamination of water courses and air, have resulted in significant environmental deterioration.

The source point of contamination entering water-ways and the environment is not always local directly in the midst of heavily populated areas nor does it occur in convenient locations where there are appropriate resources for containment and remediation, nor is the contaminate readily identifiable, in most cases the source points of contamination occur in remote areas where there is a flourishing heavy agricultural industry. The agricultural industry is one of the largest source point contributors of contaminates entering water-ways and groundwater, from there use of fertilizers, which tend to increase the nutrient load in addition to manure management issues that can be a major source point contributor of harmful bacteria such as salmonella, e-coli and listeriosis and also antibiotics that have been administered to the animals that has been transferred to the environment via their waste.

One of the many negative effects of these various types of contaminates in water is that they often rob the ecosystem of vital oxygen to form huge oxygen deprived (aka dead-zones) that restrict the natural habitats of fish and other eco marine-life. Contaminates such as hydrocarbons and manure have high viscosity that can choke-off photosynthesis and natural occurring atmospheric oxygen in large bodies of water for miles, and pharmaceutical contaminates that alter life genetics, for the most part are invisible to the eye and cannot be easily detected.

The ability to effectively remediate contaminates having varying compositions in remote locations is much desired. But, because of the varying compositions and structures of different types of contaminates it has been difficult to apply one method of remediation that will effectively remediate or render harmless all or most contaminates. Natural bacteria (microbes) can digest contaminates and convert them to carbon dioxide and water. This is called biodegration, this is a natural process that can clean water and sediment, but this method can be very slow and could take years, with a limited influx of natural accruing atmospheric oxygen. Test has shown that the biodegration process can be improved by introducing gaseous oxygen into the microbial environment to enhance and accelerate the digestion process of microbes. There are several types of microbes; bacterium microbes are much larger than microbial viruses-about one-twenty-five-thousandth of an inch long. Microbial viruses are about a millionth of an inch across. So to effectively encourage the bacterium microbe digestion of contaminates via the introduction of oxygen, the oxygen molecule would need to be a nano size relative to that of the (nano) microbe. Oxygen within or contained in a bubble would be too large for bacterium microbes to digest; in relations to oxygen in a bubble the size would be relative to a human-sized bacterium microbe, trying to digest the Sears Tower building. This bubble formation would also overcome the viscosity of waste solution to become buoyant and cause stripping of volatile pollutants and creating an air born pathogen (air pollution). Lab Test show that biodegration is limited by the amount of free available oxygen to support microbial growth. It is desirable that the nano oxygen molecule has a size relative to the nano bacterium microbe to enhance digestion and accelerate the decomposition of contaminates. It would also be much desired to have a process that creates dense multi-cell nano molecular packing of a Gaseous Element such as oxygen, hydrogen, helium, nitrogen, carbon dioxide, and/or argon in solution for enhanced bacterium microbe consumption to hyper-accelerate bacterium microbe digestion and remediation of contaminates. Such that if the dense multi-cell nano molecular gaseous element in solution is Oxygen (O₂), the resultant packed molecule would be an O₂, O₃, O₄, O₅, O₆, O₇, O₈, or O₉ or if the dense multi-cell nano molecular gaseous element in solution is Carbon Dioxide (CO₂) the resultant packed molecule would be an CO₂, CO₃, CO₄, CO₅, CO₆, CO₇, CO₈, or CO₉. The Gaseous Element may consist of Oxygen, Hydrogen, Carbon Dioxide, Nitrogen, Argon and/or Helium or combinations thereof.

Competition for increasingly scarce water in the next decade will fuel instability in regions such as South Asia and the Middle East that are important to U.S. national security, according to a U.S. intelligence report. As nations will be more likely to use water as a bargaining chip with each other, according to the report from the Director of National Intelligence. “Many countries important to the United States will experience water problems—shortages, poor water quality, or floods that will risk instability,” the study found. “North Africa, the Middle East, and South Asia will face major challenges coping with water problems.” Rising tensions over water will make resource management a higher priority in international negotiations in which the U.S. could play a role, and nations will need to play closer attention to water security. As water and hydroelectric power become more valuable, dams, irrigation projects and reservoirs could become more attractive targets for terrorists or military strikes.

Harmful contaminates such as terrorist biological threats, pharmaceuticals and microbial viruses cannot be seen, and in most cases are not detected until an outbreak occurs. These contaminates are unique because they have an inherent or engineered resistance to the effects of natural biodegration. Obviously terrorist biological threats are not designed to be biodegradable, but on the hand microbial viruses such as salmonella (salmonellosis), e-coli (Escherichia coli) and listeria (listeriosis) multiply in an oxygen rich environment and can develop muted strains when exposed to pharmaceuticals in the environment that are resistant to antibiotics. Microbial viruses such as e-coli (Escherichia coli) can grow and metabolize glucose in both the presence of oxygen (aerobic conditions) and the absence of oxygen (anaerobic conditions).

An effective method for the dissolution, disinfection and destruction of harmful contaminates such as terrorist biological threats, pharmaceuticals and microbial viruses is to deploy ionized disruptors via a photocatalytic semiconducting material having self-cleaning, self-sanitizing, self-deodorizing, self-regenerative properties as disclosed in my previous co-patents, U.S. Pat. No. 6,154,311 and U.S. Pat. No. 6,599,618 and some of my previous work publish in the book “New Weapons for New Wars Nanotechnology and Homeland Security” by Dr. Daniel Ratner and Dr. Mark A. Ratner, such that when the photon energy is greater than or equal to the band gap energy of the semiconducting material, i.e., E=3.2 eV or λ is less than ≦400 nm, an electron, e− is promoted from the valence band into the conduction band, leaving a hole behind. Some of the electrons, which have been excited into the conduction band and some of the holes in the valence band recombine and dissipate the input energy as heat. However, a number of holes diffuse to the surface of the semiconducting material and react to form SuperOxide O₂, O₃ and OH radicals, which can decompose contaminates leaving a byproduct of CO₂ and H₂O because the potential energy of the SuperOxide O₂, O₃ and OH radicals are greater than the bonding energy of the biological threats, pharmaceuticals and microbial viruses. The process would be greatly improved if the ionization of oxygen in solution to from OH radicals was enhanced by a dense multi-cell oxygen molecule consisting of O₂, O₃, O₄, O₅, O₆, O₇, O₈, and/or O₉ such that there would be an abundant increase of resulting SuperOxide O₂, O₃ and OH radicals that would hyper-accelerate the dissolution, disinfection and destruction of the molecules stellar cell wall of harmful contaminates.

U.S. Pat. No. 7,294,278 TherOx relates to the enriching of oxygen in water using several fire suppression TF6NN model nozzles as atomizers attached along a stinger running down the center of a pressure vessel distributing carrier fluid spray in a perpendicular direction to the pressure vessels walls, whereas the final effluent is based on the Reynolds Formula to calculate a Laminar flow method of delivering dissolved oxygen into a water solution via a small orifice of capillary tubes having a diameter of 150 microns (=0.005 inches) to 450 microns (=0.017 inches) and a length of 6 cm (=2.362 inches) in length, resulting in little to no bubbles. This method is would not be conducive for solutions having a viscous centipoise value of >1.0 or greater nor for wastewater having suspended solids or particulates such hydrocarbons because the particulates would not pass threw the fire suppression TF6NN model nozzles as atomizers, nor pass threw the capillaries to create laminar flow to compress the oxygen molecule, because the fire suppression TF6NN model nozzles and capillaries would easily clog, thus resulting in no flow, therefore only clean or mostly clean skimmed water can be used as a carrier fluid. Also, they state that capillaries having a larger diameter would cause the gaseous molecule not to bond in solution, therefore resulting in the formation of bubbles.

### SUMMARY OF THE INVENTION

There is provided in this invention mobile Nano Gaseous Equipment and method for creating dense nano-multi-molecular packing of gaseous molecules concentrated in liquid solutions without cavitation of nuclei and without bubbles and the ionization of the resultant solutions for the dissolution, disinfection, remediation and chemical oxidation of biological, chemical and electrochemical contaminants and threats. The present design of this Nano Gaseous equipment provides a conducive process to allow viscous fluids of wastewater with high nutrient content, water with high content of hydrocarbon oils, fuels, including crude to be processed with a admixture of multiple or singular Gaseous Element/s to create a dense molecular packing of the Gaseous Element in solution under pressure by means of a controlled meticulous adhesion disparity. This process will allow and support biological remediation of contaminates. This process would also incorporate the use of a Photocatalytic Dielectric Semiconducting Element (PDSE) having self-cleaning, self-sanitizing, self-deodorizing, self-regenerative properties to create strong SuperOxide O₂ and OH and O₃ radicals to destruct the stellar cell wall of harmful bacteria and eliminate biological, chemical and electrochemical threats and contaminates. The nano gaseous technology provides a way to infuse a Gaseous Element such as oxygen, hydrogen, helium, nitrogen, carbon dioxide, and/or argon into a Liquid Element known as a gaseous enriched Bio-Gen Solution to promote and support micro-organisms (bacteria) in a controlled bio-remediation process where as the bacteria (microbes) consume the pollutant nutrient. This technology is particularly beneficial in applications that range from homeland security, military, municipal and private wastewater treatment facilities; military and private bilge water treatment facilities; landfills; agricultural impacts to surface and groundwater; remediation of contaminated and environmentally sensitive sites such as fracking brine remediation and applications within the emergency management industry as well in remote locations where power could be an issue the Nano Gaseous equipment maybe comprised of a Molecular Continuous Flow Cell Reactor MCFCR containing a PDSE such that the PDSE may function as a alternative power generation unit to operate the Nano Gaseous equipment, making it suitable for remote applications.

### BRIEF DESCRIPTION OF THE DRAWINGS

FIG. 1 is a simplified, diagram of the Nano Gaseous Equipment;

FIG. 1b is a simplified cross-sectional view of the Degasifier;

FIG. 2 is a simplified cross-sectional view of the MCFCR demonstrating the 50% Gaseous Element and the 50% Carrier Fluid/Liquid Element;

FIG. 3 is a simplified cross-sectional view of the MCFPI;

FIG. 4 is a simplified cross-sectional view of the MCFCR comprising the PDSE within the 50% Gaseous Element and the 50% Carrier Fluid/Liquid Element;

FIG. 5 is a simplified, side view of a PDSE, demonstrating the photocatalytic reactions of titanium dioxide on the surface;

FIG. 6 is a simplified, cross-sectional view of a PDSE comprised of a substrate material having alternating layers with the first dielectric material sub-layer being tantalum oxide (Ta₂O₅), or zirconium oxide (ZrO₂) and second dielectric material being photocatalytic titanium dioxide (TiO₂);

FIG. 7 is a simplified, cross-sectional view of a PDSE comprised of a substrate material having alternating layers with the first dielectric material sub-layer being aluminum oxide (Al₂O₃)), or silicon dioxide (SiO₂) and second dielectric material having external layers of photocatalytic titanium dioxide (TiO₂);

FIG. 8 is a simplified, cross-sectional view of a PDSE comprised of a substrate material having of a plurality of alternating layers of the same material, which is photocatalytic titanium dioxide (TiO₂);

FIG. 9 is a side-view of a PDSE with a transmissive cover reflecting UV;

FIG. 10 is a cross-sectional view of a PDSE comprised of a substrate material covered by a OSB, OISB or ISB leveling layer that has a decorative/reflective layer placed on top of the OSB, OISB or ISB leveling layer, with a photocatalytic titanium dioxide (TiO₂) placed on top of the decorative reflective;

FIG. 11 is an enlarged cross-sectional view of an MCFCR demonstrating the enhanced concentration of UV reflecting;

FIG. 12 is a simplified, cross-sectional view of a MADE;

FIG. 13 is a simplified, view of a MADE having “S” bends;

FIG. 14 is a simplified, cross-sectional view of a MADE demonstrating surface disparity;

FIG. 15 is a simplified, cross-sectional view of a conical shaped MADE demonstrating surface disparity;

FIG. 16 is a simplified, view of a MADE with “S” bends incorporating fiber optics;

### DETAIL DESCRIPTION OF THIS INVENTION

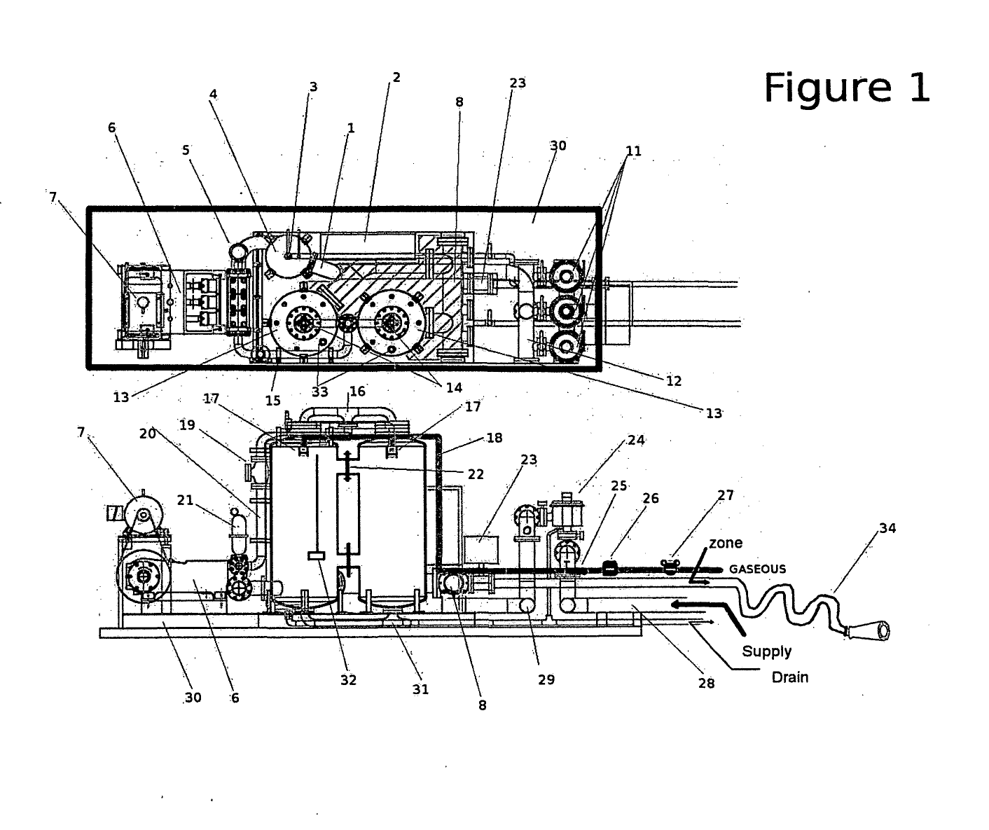

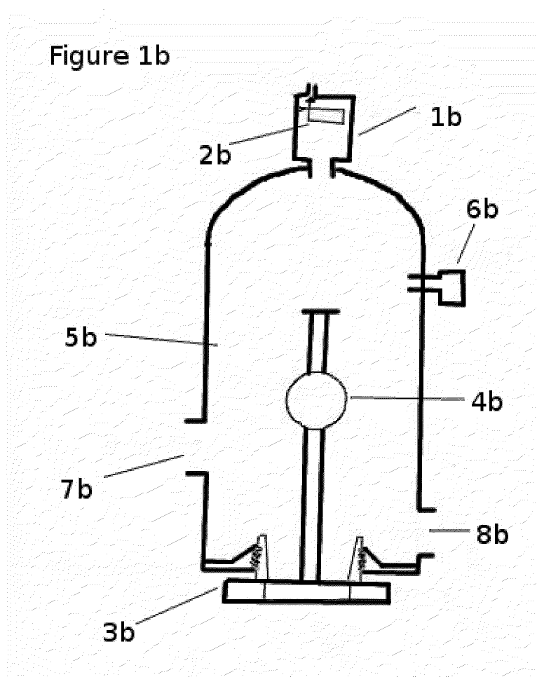

A view of the Nano Gaseous Equipment referring to FIG. 1 incorporating the process principles of this invention to create dense nano molecular packing of a gaseous elements in solution and the ionization potential thereof without cavitation of nuclei and without bubbles, for the dissolution, disinfection, remediation and/or chemical oxidation destruction of contaminants in biological, chemical, electrochemical, threats nutrient, and treatment applications.

The present design of this Nano Gaseous Equipment provides a mobile and/or stationary skid mounted unit that can be transported and deployed anywhere for the dissolution, disinfection, remediation and/or chemical oxidation destruction of biological, chemical and electrochemical threats and contaminants. The present design of this Nano Gaseous Equipment provides a conducive process to allow viscous fluids of wastewater with high nutrient content, and water with high content of hydrocarbons, oils, fuels, crude, pathogens, pharmaceuticals, chemicals, electrochemicals . . . etc. to be processed with a admixture of multiple or singular gaseous element/s to create a dense molecular packing of the Gaseous Element in solution under pressure by means of controlled meticulous adhesion disparity. This process will allow and support biological remediation of contaminates. This process will also allow for the use of a Photocatalytic Dielectric Semiconducting Element (PDSE) having self-cleaning, self-sanitizing, self-deodorizing, self-regenerative properties to create strong SuperOxide O₂ and OH and O₃ radicals with a positive ion to destruct the stellar cell wall of harmful bacteria, and destruct chemical, biological, and electrochemical threats. The Nano Gaseous Equipment provides a way to infuse a Gaseous Element such as oxygen, hydrogen, helium, nitrogen, carbon dioxide, and/or argon into a Carrier Fluid/Liquid Element known as a gaseous enriched Bio-Gen Solution without cavitation of nuclei and without bubbles to promote and support micro-organisms (bacteria) in a controlled bio-remediation process where as the bacteria (microbes) consume the pollutant nutrient. The Nano Gaseous Equipment also provides a way to infuse densely pack ionized radicals of a Gaseous Element such as oxygen, hydrogen, helium, nitrogen, carbon dioxide, and/or argon into a Liquid Element known as an enriched Ionized-Bio-Gen Solution without cavitation of nuclei and without bubbles to cause the dissolution, disinfection and destruction of biological, chemical and electrochemical threats.

### Process Controls Descriptor

Referring to FIG. 1 the Nano Gaseous equipment is comprised of one or more liquid/gaseous Molecular Continuous Flow Cell Reactor/s (MCFCR) (13) to infuse both Gaseous Elements and Liquid Elements together. The Nano Gaseous Equipment is controlled by a PLC (programmable logic controller) and a HMI (human machine interface) manufactured by Eaton Industrial Electronics. This PLC and HMI has a logic computer program that allows programming thru the HMI to all the gaseous equipment including pumps (6), carrier fluid valves/zone valves (23), gaseous valves (26), control of the concentration levels of Gaseous Elements introduced to the treatment area and all ancillary pumps, gaseous measurement meters, LMI metering pump, or peristaltic pump, accessory filtration.

The Gaseous Element/s being of gaseous nature may be supplied to the Nano Gaseous Equipment by a high pressure cylinder, a, high pressure liquid gas cylinder, or by an on-site high pressure gaseous generator. This Gaseous Element in liquid or gaseous state can include, but not limited to oxygen, hydrogen, helium, nitrogen, carbon dioxide, or argon or in combination thereof, and stored as an accessory sub-component. This gaseous source is inter-connected by a high pressure chemically inert hose, or ridged piping to an influent gaseous connector (GASEOUS). This connector is rigidly piped to a high pressure regulator (27) that controls the Nano Gaseous Equipment input pressure and can be set between 15 psi (=1.03 bar) to 400 psi (=31.02 bar) giving greater control of concentration and saturation of the carrier fluid. The regulator is piped to a back flow preventer/check valve (25) to prevent any back pressure from damaging the regulator. The back flow preventer/check valve is piped to an electric solenoid valve/ball valve (26) that is controlled by the PLC to maintain consistent gaseous positive pressure in the MCFCR (13). The solenoid valve is piped to the MCFCR with a tee that allows for a mechanical blow off valve (33) set at 450 psi maximum pressure. The PLC monitors all pressures, and has first option in the logic to control any over pressure and in the event of component failure. The mechanical blow off valve is a way to exhaust any over pressure in a controlled release.

The Liquid Element is liquid carrier fluid that is pumped from the treatment area by a field supply pump as a suction centrifugal or by a submersible pump via a hose with a gallons per minute greater than the design intake of the equipment. The supply pump hose is attached to the influent liquid connector and is hard piped to a degasifier (4). The degasifier is used in the process to trap and bleed off a coarse bubble prior to the hard piping from the degasifier to a positive displacement pump (6). The degasifier component is based on 25 percent of the gallon per minute positive displacement pump. Example a 100 gallon per minute pump would need a degasifier volume of 25 gallons. Now referring to FIG. 1B the degasifier component is fabricated from pipe, tubing with a diameter and length relative to the positive displacement pump volume. This pipe, tubing then has a welded cap (1b) affixed to the top end with a half inch pipe thread port to allow a air-trol (2b) to bleed off any gaseous element trapped in the top of the degasifier component. The bottom end has a welded cap (3b) with a 2 inch pipe plug that allows for a 1.5 inch float switch (4b) to be located inside the degasifier chamber (5b) and wired along with a pressure switch (6b). This configuration ensures that the degasifier is volumetrically full and under the necessary pressure to supply the carrier fluid to the system without cavitation or dry pump damage. The degasifier has an influent port (7b) and an effluent port (8b). Unlike the TherOx methodology that does not use a degasifier nor any means of trapping a gaseous bubble prior to pumping a carrier fluid to a vessel, which results in pump cavitation and damage to the pump caused by the supply pumps turbulent flows. Referring again to (FIG. 1) our degasifier has an influent port (1) two times the size of the positive displacement pump supply port (5) and is located 8 inches off the bottom to ensure any buoyant gaseous coarse bubbles entering the degasifier transfer out of the mainstream of carrier fluid and vented from the air-trol. The effluent port is located at the bottom below the influent port ensuring all carrier fluid has been degassed and a continuous flow of liquid carrier fluid. The positive displacement pump takes a 60 psi influent pressure up to the operating pressure of the MCFCR pressure. The positive displacement pump is hard piped to a check valve (19) preventing any back pressure in to the positive displacement pump. This check valve (19) is hard piped to a Molecular Carrier Fluid Poppet Injector (MCFPI) (17). The MCFPI spray is collective in the bottom 50% of the MCFCR and monitored by a differential pressure transducer (32) with a high pressure port hard piped to the bottom of the MCFCR in the liquid carrier fluid portion and the low pressure hard piped to the gaseous portion of the MCFCR. The pressure transducer measures the gaseous pressure against the bottom port pressure and the weight of the water column creating a differential pressure signal to the PLC and is interpolated into a variable positive displacement pump speed to control and maintain a positive carrier fluid level.

The lower portion of the MCFCR has a carrier fluid effluent port (8) located approximately 6 inches off the bottom of the flow cell. This port is hard piped to a carrier fluid header (8) with multiple porting to allow for singular or multiple valving controlled by the PLC. The valving train is known as zone valves (23), which enables the PLC to control the enriched carrier fluid direction to a single or to multiple treatment. The zone valves (23) are connected by zone tubing that can be ridged pipe or of a poly material such as PEX flexible tubing that is directed from the base Nano Gaseous Equipment to one or more treatment areas. One end of the zone tubing is interconnected to the zone valve with the opposing end connected to one or more mechanically affixed Meticulous Adhesion Disparity Elements (MADE/s) (34) to enable delivery of the enriched carrier fluid (Liquid Element/Bio Gen Solution) without cavitation of the nuclei and without forming a bubble to the treatment area.

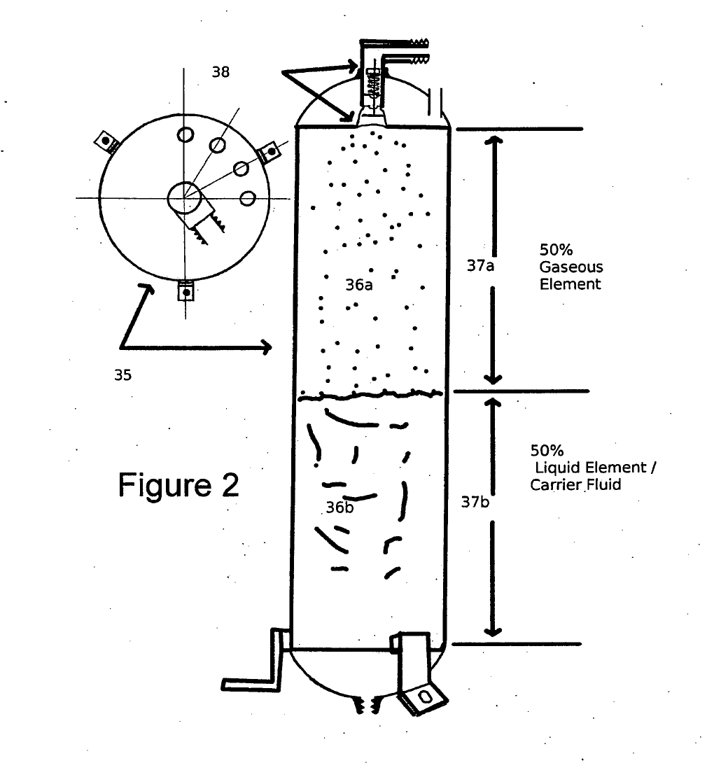

Referring to (FIG. 2) the Molecular Continuous Flow Cell Reactors (MCFCR) (35) are constructed of a material or combination of materials that are suitable for a pressure environment, and that will remain stable so as not to degrade and/or react to the gaseous elements (36a) or carrier fluid/liquid elements (36b), such materials may include but are not limited to composite materials, composite fiber materials, metal alloys, metals and/or combinations thereof, preferable the MCFCR (35) is constructed of stainless steel single one piece welded construction. The MCFCR is fabricated of a specially engineered design having a vertical orientation with a height and diameter relative to the flow-rate in gallons-per-minute (gpm) of the liquid element to maintain a reaction equilibrium with the gaseous element, such that a 50% percent free head of gaseous element (37a) and 50% percent of liquid element (37b) occupy the total volume capacity of the MCFCR to maintain equilibrium within the MCFCR, and maximize the carrier fluid contact time, which results in higher levels of gaseous carrier fluid. Such that if the gaseous equipment is a 15 gpm unit, the MCFCR would have a volume of 30 gallons, if the gaseous equipment is a 20 gpm unit, the MCFCR would have a volume of 40 gallons, if the gaseous equipment is a 30 gpm unit, the MCFCR would have a volume of 60 gallons, if the gaseous equipment is a 40 gpm unit, the MCFCR would have a volume of 80 gallons, if the gaseous equipment is a 50 gpm unit, the MCFCR would have a volume of 100 gallons, if the gaseous equipment is a 100 gpm unit, the MCFCR would have a volume of 200 gallons, . . . etc. so that within the MCFCR a reaction equilibrium of a 50% percent free head of gaseous element (37a) and a 50% percent volume of liquid element (37b) is maintained.

As illustrated in (FIG. 1), the Nano Gaseous Equipment is comprised of two MCFCR's, such that if the gaseous equipment is a 50 gpm unit, the Gaseous Equipment may incorporate a co-dependent design having two MCFCR's, with each MCFCR receiving 25 gpm of liquid element, thus each co-dependent MCFCR would have a total volume of 50 gpm in order to maintain equilibrium between the Gaseous Element and the Liquid Element with each occupying 50% percent of the volume of each co-dependent MCFCR to make up 100%. The co-dependent MCFCR's are connected by an intake Gaseous and Liquid equilibrium module (22) so that the intake of both the Gaseous Element and the Liquid Element and conditions of the co-dependent MCFCR's are identical.

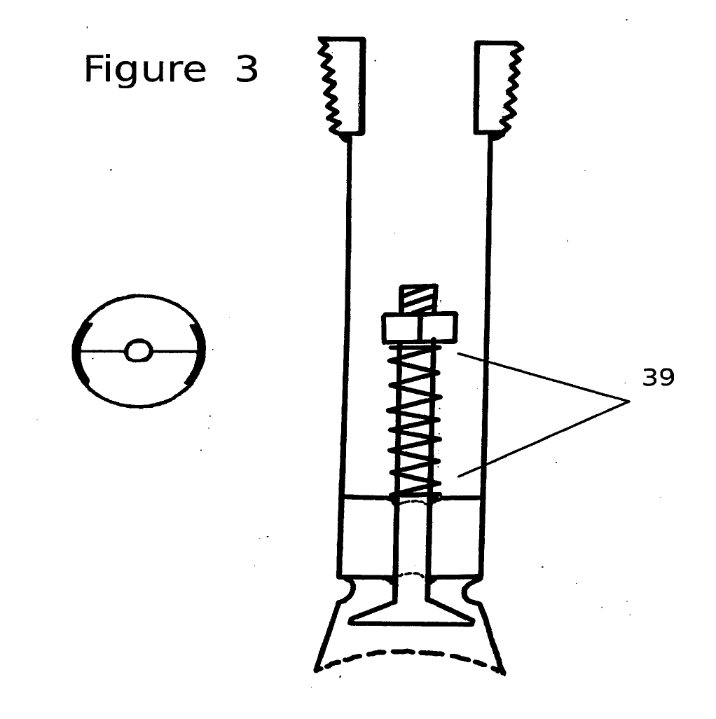

Referring to (FIG. 2) mounted to the upper most portion of the MCFCR's welded cap is a specially designed conical shaped Molecular Carrier Fluid Poppet Injector (MCFPI) (38). The MCFPI is secured by means of pipe thread to allow for a positive seal and easy removal if maintenance is needed. Referring to (FIG. 3) a sectional view of the MCFPI incorporating design features of the singular MCFPI that is affixed top-dead-center to the upper most top of the MCFCR gaseous flow cell. The MCFPI has an orientation parallel to the side walls of the MCFCR having an equal distance from the side walls of the MCFCR all the way around so that the MCFPI is centered. The MCFPI is comprised of a stainless steel 90 degree compression fitting with 1 inch pipe thread on the opposing end and has a three quarter inch tube 4 inches long welded to the threaded end. The 4 inch length tube has an internal crimped radius at a half inch from the bottom that allows for a threaded stem with a circular flared end to seat against. This stem fits inside of the tubing with a spring, loaded with approximately 1 pound of tension. The tension allows for the stem to open with resistance against the variable carrier fluid flow that creates a conical micro fine spray pattern thru the gaseous element creating greater enrichment of the carrier fluid. This MCFPI is designed and manufactured by Bio Energy Corporation and allows for greater variables in flow rates maintaining a micro fine conical spray pattern. This injector could be made in larger diameters or used in multiples for larger flow rates of 5000 gallons per minute or more. The MCFPI's specially designed spring loaded injector core (39) allows it to compensate and work at variable flow rates and pressures to maintain a very fine conical atomization spray pattern whether the flow rate fluctuates from 1 gpm to 50 gpm, so that the spray pattern remains at a constant, and is continuous. The MCFPI's specially designed spring loaded injector core (39) allows for viscous wastewater carrier fluids having micro particulates and/or solid elements to pass thru the MCFPI without blinding the injector while maintaining a constant and continuous spray pattern. The MCFCR containing the MCFPI may be constructed in varying sizes, but it is preferably that the diameter of the MCFCR is 36 inches or less, and in a vertical orientation so that the carrier fluid distributed from the MCFPI has extended contact time with the 50% percent free head of gaseous element in order to maximize saturation of the carrier fluid with the Gaseous Element, thus forming the Liquid Element. The design and methodology allows for the MCFPI's injector to distribute a conical downward vertical fine atomized spray pattern that is parallel to the flow cell walls, so as not to contact the walls of the MCFCR and not to impede the interaction, and/or reactions of the carrier fluid saturation with the Gaseous Element. It is desired that the distance of descent of the carrier fluid distributed from the MCFPI through Gaseous Element to the Liquid Element is not less than 1½ ft. (feet), but it is preferred that the distance is 2 ft. or more to maximize the carrier fluid contact time with the Gaseous Element. The MCFCR and MCFPI provides a more efficient method for infusing a Gaseous Element into a Carrier Fluid/Liquid Element at a high gallons-per-minute (gpm) rate without blinding or clogging and effectively replaces the need to use a plurality of nozzles as does the TherOx method that uses fire suppression nozzles manufactured by BETE nozzle model TF6NN with a fixed orifice of 0.090 in diameter and only flows 3.5 gallons per minute at 300 psi with a spiral blade in front of the orifice to create a coarse water droplet, atomization spray. This method would require 15 spray nozzles to operate at 50 gpm and at a 25 gpm rate the nozzle configuration would reduce flow and would not allow enough volume to atomize the spray, and the nozzles are prone to blinding and clogging from micro particulates and solid elements.

To those skilled in the art it would be clear that the function and methodology of the MCFCR is designed to create a longer spray pattern with greater surface area and contact time with the gaseous element resulting in greater efficiencies and greater concentration levels of Liquid Element. Thus using the waste water as carrier fluid at a maximum saturated concentration of a gaseous element and using our Meticulous Adhesion Disparity Element (MADE) hollow flow thru body design to allow mixing waste water with gaseous saturated carrier fluid (Bio-Gen Solution) as a means of diluent to achieve and control desired gaseous levels.

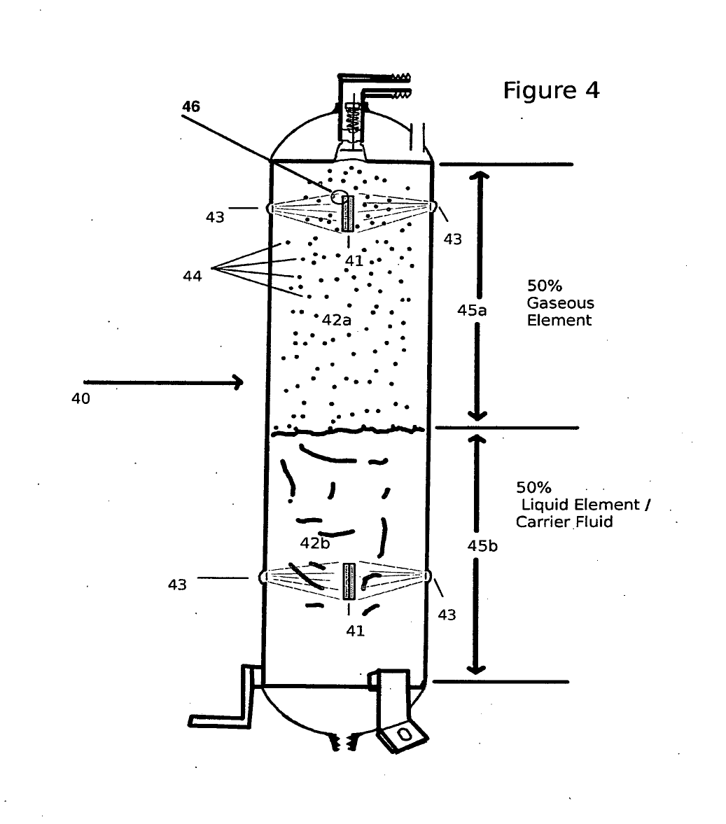

Referring to (FIG. 4) MCFCR may be comprised of one or more Photocatalytic Dielectric Semiconducting Elements (PDSE) (41) within the MCFCR (40) that reacts with the Gaseous Element (42a) and the Liquid Element (42b) within the MCFCR to from strong ionized radicals having self-cleaning, self-sanitizing, self-deodorizing and self-regenerative properties, capable of the dissolution, decomposing and destruction of biological, chemical and electrochemical threats. The PDSE utilizes a thin dielectric film placed on a substrate to achieve photocatalytic reactions within the MCFCR with high UV absorbance, reflectance and/or high photopic transmittance. This reaction forms strong SuperOxide O₂ and O₃ and OH radicals (disruptors), capable of destroying microbial viruses such as, but not limited to salmonella (Salmonellosis), e-coli (Escherichia Coli) and listeria (Listeriosis), and capable of the dissolution, decomposition and destruction harmful contaminants, biological, chemical and electrochemical threats leaving a resultant by-product of CO₂ and H₂O, because the potential energy of the radicals generated by the PDSE is greater than the bonding energy of the harmful contaminants, biological, chemical and electrochemical threats. Sources of UV within the MCFCR may include but are not limited to sunlight, single and/or multi-mode fiber, light emitting diode (LED), fluorescent lamps, mercury lamps, gas-discharge lamps . . . etc. (43) that may be positioned in various locations within the MCFCR to optimize the photocatalytic response of the PDSE. The PDSE/s may be positioned in various locations within the MCFCR to optimize the photocatalytic response of the PDSE and to maximize generation of ionized radicals within the 50% of gaseous head (45a) of the Gaseous Element (45b) and/or within the 50% volume of the enriched carrier fluid now referred to a the Liquid Element. Preferably one or more PDSE/s are positioned within the 50% of gaseous head of the Gaseous Element, such that a Gaseous Element contacting the PDSE and the deposition of the atomized carrier fluid (44) from the MCFPI contacting the PDSE create ionized SuperOxide O₂ and O₃ and OH radicals thus enriching the Liquid Element with ionized radicals. This infusion process of ionized gaseous element and liquid known as a coarse ionized gaseous enriched carrier fluid/Liquid element collectively forms in the bottom 50% of the MCFCR whereas, after a one minute stabilization period allows for a consistent concentration of the coarse ionized gaseous enriched carrier fluid. The coarse ionized gaseous enriched carrier fluid is then directionally piped to one or more zone valves then piped as coarse ionized gaseous enriched Liquid Element to the Meticulous Adhesion Disparity Element/s (MADE/s), whereas the MADE/s creates multi-dense packing of the ionized SuperOxide O₂, OH and O₃ radicals and creating a molecular bonding of the ionized radicals to the liquid and discharges a Ionized Bio-Gen solution. This Ionized-Bio-Gen solution is a truly dissolved ionized gaseous element with no cavitation of nuclei and with no formation of a bubbles, thus creating a supersaturated Ionized-Bio-Gen solution having self-cleaning, self-sanitizing, self-deodorizing capabilities and an Ionized-Bio-Gen solution capable of the dissolution, decomposition and destruction of harmful contaminants, biological, chemical and electrochemical threats.

The PDSE herein disclosed comprises a substrate upon which a number of alternating layers of thin dielectric films are deposited. The substrate can be transmissive for all wavelengths of light or non-transmissive to wavelengths of light, but in both cases the dielectric film is highly reactive to wavelengths of light within a predetermined spectrum and is otherwise transmissive. The PDSE can be an optically clear multilayered hard durable thin film comprised of an external contact layer of photocatalytic semiconducting titanium dioxide (TiO₂), the TiO₂ may be partially composed of its brookite, rutile, and/or anatase phase, but preferable the TiO₂ is in the anatase phase having photocatalytic properties that reacts to greater than 90% of all UV with a series of tailored thin film dielectric layers designed with narrow contoured spectral bandwidths to react to UV within a predetermined spectrum. The PDSE can filter light and reacts to UV from a UV output source, which can come from a sunlight, light emitting diode (LED), fluorescent lamps, mercury lamps, gas-discharge lamps . . . etc., the UV is then reflected back to the external contact layers of the PDSE producing a concentration of UV at the external surface of the PDSE, thus initiating self-regenerative photocatalytic reactions of titanium dioxide (TiO₂).

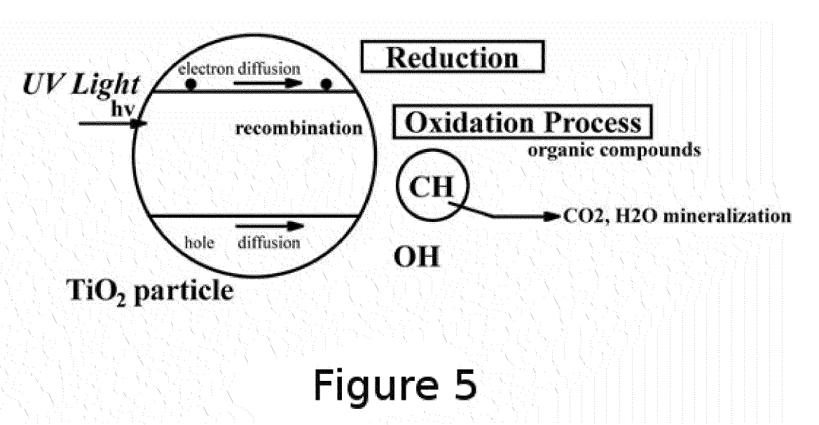

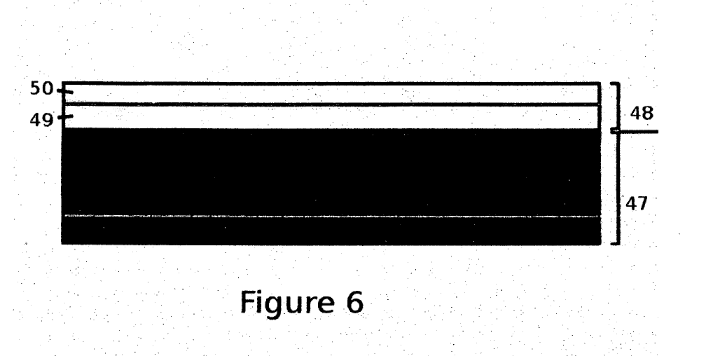

A sectional view of a PDSE (46) functioning within the MCFCR (40) referring to (FIG. 4) incorporating the principles of this invention is shown in (FIG. 5) in which anatase TiO₂ is the photocatalytic material. When the photon energy is greater than or equal to the band gap energy of TiO₂, i.e., E=3.2 eV or lambda (λ) ≦400 nm, an electron, e− is promoted from the valence band into the conduction band, leaving a hole behind. Some of the electrons which have been excited into the conduction band and some of the holes in the valence band recombine and dissipate the input energy as heat. However, a number of holes can diffuse to the surface of the TiO₂ and react with the Gaseous Element and the Carrier Fluid/Liquid Element within the MCFCR forming OH absorbed on the surface. This reaction forms SuperOxide O₂, OH radicals and O₃ radicals that are capable of the 0.20 dissolution, decomposition and destruction of harmful biological, chemical and electrochemical contaminants, thus leaving a resultant by-product of CO₂ and H₂O, greatly because the potential energy of the OH radical is greater than the bonding energy of almost all contaminates. Referring to (FIG. 6), thin dielectric film layers 48 are deposited upon a substrate material 47 that maybe composed of but not limited to metals, metal alloys, composites, glass, plastics and materials such as Polytetrafluoroethylene (PTFE), Polyethylene Terephthalate (PET), Polyethylene Terephtalate Glycol-modified (PETG) or combination thereof. The thin dielectric film layers 48 are comprised of a plurality of alternating layers 49, 50 wherein each of the alternating layers has a high index of refraction so as to maximize the angular bandwidth reflected. Preferably the material forming each of the two alternating layers has an index of refraction greater than 2.0. Additionally, the difference in the refractive index of the materials forming each of the two alternating layers is as small as possible to also increase the reflected angular bandwidth.

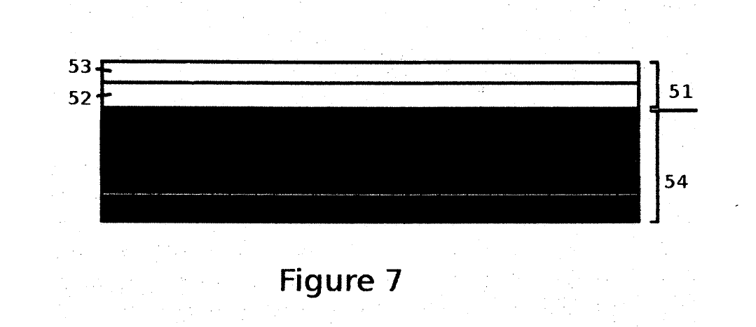

Preferably, the thin dielectric film 48 is formed of a plurality of alternating layers of photocatalytic titanium dioxide (TiO₂) 50, having an index of refraction of 2.49, and sub-layers either tantalum oxide (Ta₂O₅) 49, or zirconium oxide (ZrO₂), each of which having an index of refraction of 2.25. Alternatively referring to FIG. 7, the thin dielectric film layers 51 may be comprised of a plurality of sub-layers of aluminum oxide (Al₂O₃) 52 and photocatalytic titanium dioxide (TiO₂) 53, or sub-layers of silicon dioxide (SiO₂) and external layers of photocatalytic titanium dioxide (TiO₂) which are alternatively deposited upon the substrate 54, however, other compounds could be utilized if they are durable and have appropriate indices of refraction for the wavelength of light which is desired to be reflected. The external surface layer 50, 53 of the plurality of layers are composed of photocatalytic titanium dioxide (TiO₂) to induce photocatalytic reactions on the surface of the PDSE within the MCFCR, additionally dielectric film layers 48 and 51 are designed to reflect light waves with a wavelength within a predetermined spectrum, as hereinafter described, while remaining highly transmissive for light waves of all other wavelengths. While the layers may be of any desired thickness, the layers are preferably of the third order such that the mechanical thickness of each of the individual layers is determined by the formula:

mechanical thickness=(3×λ)/(4×n)

Where Lambda “λ” is the wavelength of light to be reflected by the PDSE and “n” is the index of refraction of the material forming the particular layer. By utilizing third order layer the number of necessary layers is deceased to simplify the design and fabrication of the PDSE. The formula assumes a 0° angle of incidence between the incident light wave and a line perpendicular to the surface of the PDSE. The wavelength of light to be reflected may thus be precisely controlled by the choice of an appropriate thickness for the individual dielectric layers. The thin photocatalytic titanium dioxide (TiO₂) layers 50, 53 and sub-layers 49, 52 may be deposited upon the substrate 47, 54 by any of the traditional methods utilized for dielectric deposition such as Electron Beam Physical Vapor Deposition (EBPVD). Two environmentally stable coating methods for producing dielectric films are available, Reactive Ion Plating Deposition (RIPD) and Ion Assisted Deposition (IAD). Both are vacuum deposition methods that produce dense, hard dielectric thin films without columnar microstructures and can be produced by similar ion beam technology. Both Optical Coating Laboratory, Inc. of Santa Rosa, Calif. and Omitec Thin Films Ltd., of Tomes, England are examples of facilities where dielectric thin films made using IAD techniques and tailored as demanded by performance requirements, can be applied. Both processes are also desirable because they enable multiple identical PDSE's to be produced within a vacuum chamber at the same time.

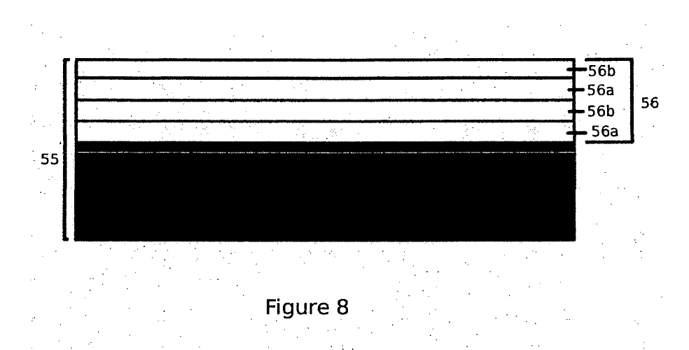

An alternative embodiment is provided referring to FIG. 8, whereby the PDSE 55 is comprised of a plurality of alternating layers of the same material, which is photocatalytic titanium dioxide (TiO₂) dielectric film 56 are comprised of the same material. In this alternative embodiment the layers while being comprised of the same material are deposited in an alternating fashion by reactive ion plating and evaporative coating.

Reactive Ion Plating Deposition provides a layer 56a of the material which is denser than that provided by Evaporative Coating 56b due to air gaps in the material introduced by evaporative coating. Thus the index of refraction of the material deposited by Reactive Ion Plating Deposition is greater than that of the same material deposited by Evaporative Coating. Thus we are able to enhance the growth of the developing film by using the secondary ion source 10 eV-100 eV to knock off, shake lose and scatter weaker molecules and allow for more dense packing of molecules within the film structure. The difference in the index of refraction of 0.2-0.3 is observed for photocatalytic titanium dioxide (TiO₂) 56. Since the same materials is being deposited by both the Reactive Ion Plating Deposition 56a and the Evaporative Coating methods 56b, the coefficient of thermal expansion of the layers is identical although the index of refraction of the layers vary. Since the coefficient of thermal expansion is identical between the plurality of layers, each layer will expand or contract at an equivalent rate such that delamination do not occur. However, the plurality of layers forming the thin dielectric film 56 will provide alternating layers of differing index of refraction so as to provide the necessary reflection of UV within the desired wavelength band to enable the PDSE 55 to properly function as referenced in FIG. 5. The alternating layers of photocatalytic titanium dioxide (TiO₂) 56a and 56b may also be deposited in optical thicknesses of a quarter wavelength κλ/4, to achieve the desired thickness and to maximize the photocatalytic potential of the PDSE 55 relative to a predetermine UV wavelength.

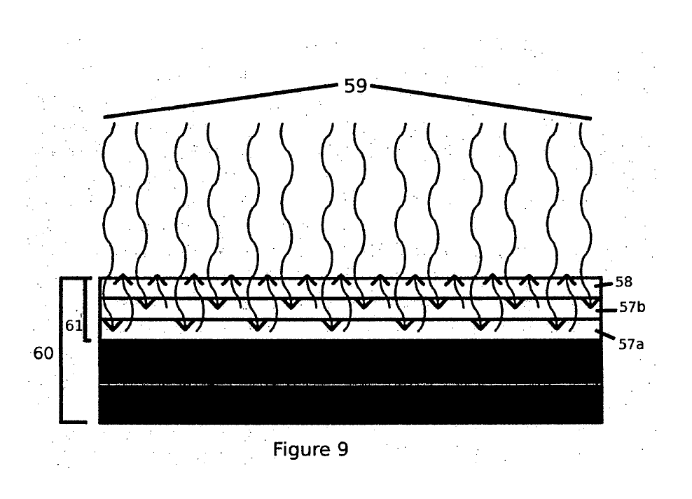

An additional embodiment referring to FIG. 9, is provided whereby a plurality of alternating layers of photocatalytic titanium dioxide (TiO₂) 57a,b is designed to filter and reflect light waves of a certain wavelength within a predetermined spectrum, is covered by a transmissive layer 58, chosen so as to be transmissive for light at all wavelengths, to form a PDSE sub-stage concentrator 60, that reflects greater than 90% of UV 59 back through to the surface of the transmissive layer stack 61 of the PDSE 60. By allowing light of all wavelengths to pass through the transmissive layer, the light can then be filtered by the plurality of dielectric films underneath 57a,b, within a predetermined spectrum to reflect UV back through to the surface of the transmissive layer, thus increasing UV at the surface of the transmissive layer by two fold and also producing an excellent UV resistant barrier. Though electrons of the photocatalytic titanium dioxide (TiO₂) 57a,b could force through the transmissive dielectric film 58 to induce photocatalytic reactions on the surface of the PDSE 60 in the presence of UV, also this embodiment functions as an excellent UV reflective concentrator to reflect a concentration of UV to an alternate PDSE to induce photocatalytic reactions.

The PDSE sub-stage concentrator 60 is formed of a plurality of alternating layers of photocatalytic titanium dioxide (TiO₂) 57a,b having an index of refraction of 2.49, alternatively, the thin dielectric transmissive cover film 58 may be comprised of a plurality of layers of aluminum oxide (Al₂O₃), silicon dioxide (SiO₂), tantalum oxide (Ta₂O₅), and/or zirconium oxide (ZrO₂) that are alternatively deposited upon the photocatalytic titanium dioxide (TiO₂) 57a,b, however, other compounds could be utilized if they are durable and have appropriate indices of refraction for the wavelength of light that is desired to be reflected. In this embodiment, the plurality of photocatalytic titanium dioxide (TiO₂) layers are covered by a transmissive layer 58 composed of silicon dioxide (SiO₂).

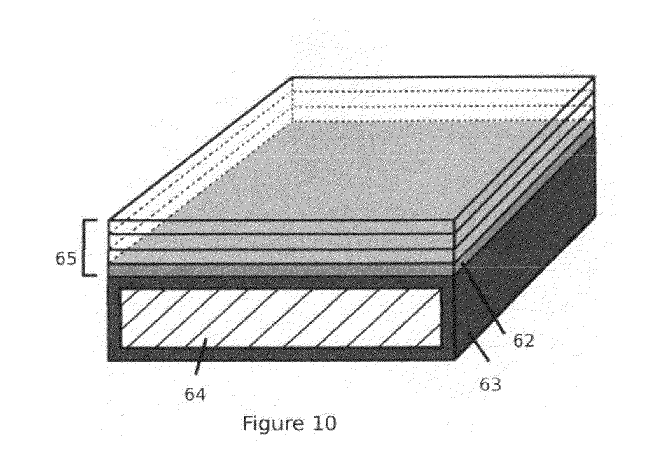

An additional preferred embodiment is a PDSE comprised of a decorative/reflective layer 62 as referenced in (FIG. 10) to provide high UV reflectance resulting in enhanced photocatalytic activity of the PDSE within the MCFCR. The decorative/reflective layer 62 is of a deposition vacuum deposited material, in pure form, oxide form, nitride form or oxynitride form, such as a deposition chrome (Cr), silver (Ag), gold (au), platinum (Pt), aluminum (Al), titanium (Ti), zirconium (Zr), nickel (Ni), tin (Sn) etc. The decorative/reflective layer/s may be placed on top, underneath or within a hard durable film coating that may be comprised of both organic and inorganic interfacial and prima layers, which may include an organic poly-plate barrier coating (hereinafter “OPB” coating), an inorganic surface barrier coating (hereinafter “ISB” coating), or an organic/inorganic surface barrier coating (hereinafter “OISB” coating). Suitable OPB, ISB, and OISB coatings are furnished by Adsil Inc, in Daytona Beach, Fla. The OPB, ISB and OISB coatings 63 are clear high temperature coatings that can provide a hard suitable bridge layer capable of supporting the decorative/reflective layers, photocatalytic titanium dioxide (TiO₂) layers, and/or other layers having functional properties placed on top. The OPB, ISB and OISB coatings may also be placed over the decorative/reflective layers to protect the layers, thus making them less susceptible to degradation. The OPB, ISB and OISB coatings may also be used to protect, level and smooth raw, dull or unfinished substrates 64 to provide a suitable specular interfacial prima layer for the decorative/reflective, photocatalytic titanium dioxide (TiO₂) and other functional layers 65. The OPB, ISB and OISB 63 are hard, clear high temperature coatings that can be deposited on most any substrate material, including but not limited to plastics, metals, alloys, polymers, glass and/or composites, with good adhesion. OPB, ISB and OISB coatings are typically applied by dip and/or spin coating. When hardened, the OPB, ISB and OISB coatings provide a clear, specular, level, smooth, hard surface over all exposed areas of the substrate. Micro pores as we call them are undetectable by the eye, but can be seen under SEM (Scanning Electron Microscope). These micro pores can cause serious corrosion problems when the underlying substrate material is metal. Though the thin film layers can be inert and corrosion resistant, the porous nature of the substrate material structure can cause galvanic cells to set up, and begin corroding, and eroding the underlying material that the thin film layers are placed upon. This is why an OPB, ISB and OISB coating is needed to provide added insurance and reduce the likely hood of coating failure on metal castings. Preferable the OPB, ISB and OISB coatings has a 3-phase or 3-stage interlock or cross-linking of bonds, the first interlock occurs after solvent evaporation, the second interlock can occur when the OPB, ISB and OISB coatings are introduced to infra-red (IR), and the final interlock occurs during light Ion bombardment of the OPB, ISB and OISB coatings in the vacuum chamber prior to the deposition of the decorative/reflective layer and other deposition layers.

When a functional layer having decorative/reflective properties is placed over an OPB, ISB, and/or OISB leveling layer of a rough unfinished substrate having a non-specular surface the surface becomes level and specular. Such substrates having a rough unfinished non-specular surface would traditionally need to be electro-polished, buffed, or electroplated to provide a smooth level surface to achieve a bright specular finish. Whereas, when an OPB, ISB, and/or OISB inner bonding layer is placed over a rough unfinished non-specular surface of a substrate it provides surface leveling, substrate containment, corrosion resistance, environmental protection and a specular finish. The in addition to the photocatalytic titanium dioxide (TiO₂) layer, the PDSE may also include one or more functional layers 65 having varying properties placed over the OPB, ISB, and/or OISB layer to support and protect the decorative/reflective layer and substrate. An OPB, ISB, or OISB coating may also be placed over the decorative/reflective functional layer to provide corrosion and environmental protection. The PDSE may also include a photocatalytic titanium dioxide (TiO₂) layer placed over the OPB, ISB, and/or OISB layer, which when exposed to a irradiation of light provides self-cleaning, capabilities over the surface of the substrate able to decomposes most organic and some inorganic contaminates that contacts the surface. The PDSE may also include a hydrophilic layer partially placed over specific areas of photocatalytic titanium dioxide (TiO₂) layer, such as to draw more moisture from the Gaseous Element and Carrier Fluid/Liquid Element for increased formation of superoxide O₂, O₃ and OH radicals to enhance its photocatalytic response.

An alternative embodiment is provided whereby The photocatalytic titanium dioxide (TiO₂) film is placed on the PDSE substrate by a Sol-Gel Method that comprises one or more layers of photoreactive gelatin which have be subsequently developed by wet chemical processing. In which a substrate is dipped into a titanium alkoxide solution, TPT monomer or polymer chelated with glycol polymer. They're maybe variations in the mixture as far as what is used but the process manner is the same, whereas the substrates are pulled out, and the rate in which the substrate is pulled out determines the coating thickness. The coated substrate is then heated at about 600 degrees ° C. to form the crystalline anatase phase. NanoSurfaces s.r.l. of Milano, Italy is an example of a facility where sol-gel films are made using techniques that are tailored as demanded by performance requirements, and can be applied.

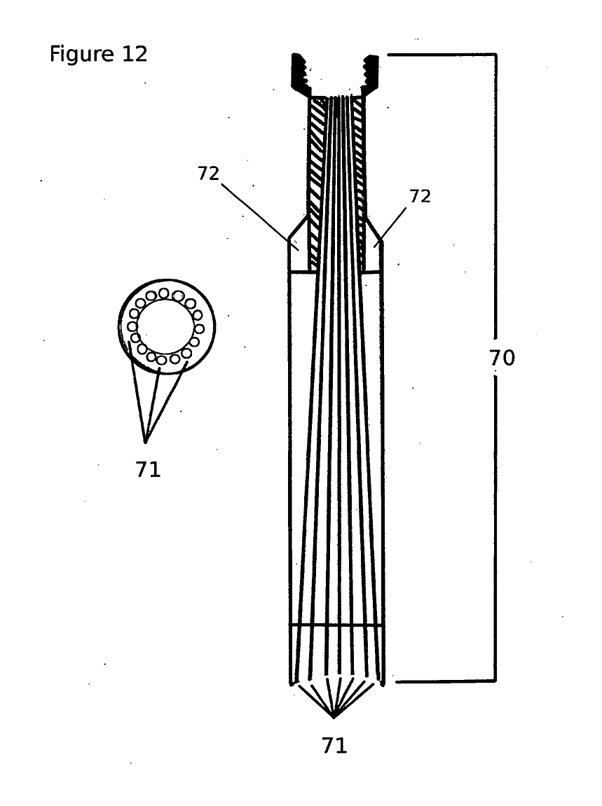

Referring to (FIG. 12) The Nano Gaseous Equipment is comprised of a Meticulous Adhesion Disparity Element (MADE) 70 consisting of one or more tubular element/s 71 having a controlled surface disparity along the inner channel and inner walls of the tubular element/s to create an interior roughness to modify and enhance the friction of the Liquid Element passing thru its length causing it to become greater, whereas the meticulous adhesion disparity creates multi-dense packing of the Gaseous Element thus creating covalent molecular bonding of the Gaseous Element to the Liquid Element, so that the resultant discharge back into an atmospheric treatment reactor, waste stream, body of water or lake is a Bio-Gen Solution, whereas this Bio-Gen Solution is a truly dissolved Gaseous Element with no cavitation of the nuclei and no formation of a bubbles, therefore being relative in size to molecular organisms and capable to effectively and efficiently support microbial growth and chemical treatment. Whereas the dense molecular gaseous packing of a Gaseous Element such as oxygen (O₂) in a Bio-Gen Solution perennially cycling through the Nano Gaseous Equipment and MADE obtains a resultant dense multi-cell oxygen molecule consisting of O₂, O₃, O₄, O₅, O₆, O₇, O₈, and/or O₉.

Whereas dense molecular gaseous packing of a Gaseous Element such as carbon dioxide (CO₂) in a Bio-Gen Solution perennially cycling through the Gaseous Equipment and MADE obtains a resultant dense multi-cell molecule consisting of CO₂, CO₃, CO₄, CO₅, CO₆, CO₇, CO₈, or CO₉. The Gaseous Elements may consist of Oxygen, Hydrogen, Carbon Dioxide, Nitrogen, Argon and/or Helium or combinations thereof.

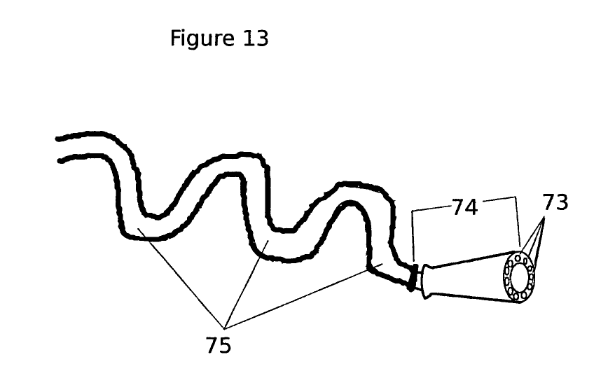

Referring to (FIG. 13), in addition to the controlled surface disparity within the channel and walls of the element tubing 73 comprising the MADE 74, the element's tubing could also include multiple mechanical S-bends 75 stacked to approximately 6 to 8 inches apart. This would allow for greater surface adhesion disparity allowing for a longer tubing comprising the MADE to be packaged in a modular shorter space for treatment of heavy viscous fluids.

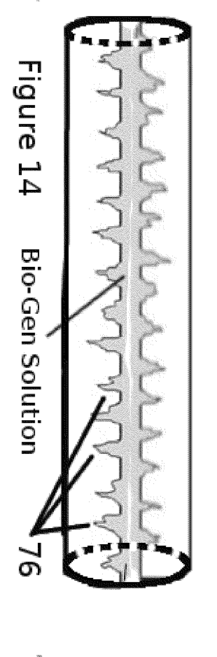

Referring again to (FIG. 12) the MADE 70 may be constructed of a material or combination of materials that are suitable for a pressure environment, and that will remain stable and have little to no degradation and/or have little to no reaction to the Gaseous Elements nor to the Liquid Elements, such materials may include but are not limited to composite materials, composites, composite fiber materials, glass, metals, metals alloys, plastics and materials such as Polytetrafluoroethylene (PTFE), polypropylene, silicone, and/or combinations thereof. The suitable material would be chemically inert to the Gaseous and Liquid Elements traveling through the tubular channels of the MADE/s element/s having a surface that is modifiable to achieve the right amount of controlled meticulous adhesion disparity surface tension within the elements tubular channels 71 to create a dense molecular packing of the Gaseous and Liquid Elements as such the Gaseous and Liquid Elements become molecularity bonded to prevent any cavitation of the nuclei, therefore there is no formation of a buoyant gaseous bubble. Preferably the MADE 70 and its tubular element channels 71 are constructed of stainless steel. Referring to (FIG. 14), the manufacturing process of the tubular element/s could be formed from a flat sheet or a strip roll of suitable material that would have the finish surface modified to a specific surface roughness 76 by means of using several different methods used for surface modification including but not limited to: Deep Reactive-Ion Etching (DRIE), photochemical etching, industrial etching methods, wet etching, acid etching, sanding, grinding, or other methods of modified surface finishes. This material then would be sheared, cut, and trimmed to a width equal to the circumference of the desired internal finish diameter by means of mechanical roll forming, stamping, or other tubular forming processes. This tubular material would then be processed thru a micro fusion process applicable to the materials adhesion either by micro welding, a bonding adhesive, or thermo fusion of the linear cold joint equal to the structural integrity embodiment material. Referring to FIG. 12 The diameter of the MADE's tubular element/s 71 may consist of varying diameters having a maximum diameter of up to 2″ inches, preferably the MADE's tubular element/s 71 have a diameter ranging from 1000 microns (=1 millimeter=0.0393 inches) to diameter of 6350 microns (=0.250 inches). The length of the element tubing comprising the MADE is determined by the viscosity of the solution, size and volume of solid suspended particulate and the controlled surface disparity 76 to the interior wall of the passage way. The MADE's design and method of meticulous adhesion disparity is well suited in treatment applications for solutions having a viscous centipoise value of >1.0 or greater and for wastewater solutions having suspended solids and/or particulates so as to create multi-dense molecular packing of Gaseous Element/s to create covalent molecular bonding to Liquid Element/s forming a truly dissolved gaseous solution without cavitation of the nuclei and without formation of a bubbles so that the resultant discharge back into an atmospheric treatment reactor, waste stream, body of water or lake is a Bio-Gen Solution. The MADE's design and method of meticulous adhesion disparity allows for use of much larger diameters to prevent clogging and blinding of its tubular elements, and thus overcomes the limitations of using glass capillary tubes having a diameter of 150 microns (=0.005 inches) to 450 microns (=0.017 inches) and having a length of 6 cm (=2.362 inches) as used in the TherOx method of Laminar Flow.

The MADE's design and method of meticulous adhesion disparity is well suited in treatment applications for solutions such as bio-remediation of municipal waste, which has a matrix of viscous fluid, suspended solids, micro fibers, industrial chemical and organic pollutants.

The MADE's design and method of meticulous adhesion disparity is well suited in treatment applications such as hydrocarbon emulsification and remediation of viscous crude, processed lubricants, fuels, glycols, and other forms of manufactured products derived from crude are very and conducive to this treatment process.

The MADE's design and method of meticulous adhesion disparity is well suited in treatment applications such as chemical oxidation treatment of arsenic and of fluids having a viscosity with a centipoise (cP) value of ≦1 or greater.

The MADE's design and method of meticulous adhesion disparity is well suited in treatment applications such as agricultural manure management of nutrient loading to enable the biological remediation process to treat phosphorous, ammonia, nitrite, nitrates, hydrogen sulfide and consume the nutrient loading rendering greater quality of waste water.

The MADE's design and method of meticulous adhesion disparity is well suited for desalination treatment applications whereby sea water enriched with high concentrations of calcium become crystallized calcium by the infusion of multi-dense molecular packing of carbon dioxide gas forming a calcium-bicarbonate crystal that can be then filtered out rendering a solution that could be disinfected using the PDSE, thus creating potable water meeting standards for human consumption.

Referring to FIG. 13 the MADE's configuration channel 75 could be straight with a length of one foot to ten feet or could have multiple stacked S bends with a length of twenty feet to create greater mechanical meticulous adhesion disparity. Referring to (FIG. 12) the MADE's 70 design is comprised of multiple element tubing's 71 affixed to a tubular header manifold having sufficient spacing between each of the element tubing's comprising the MADE to allow for dilution water (72) to fully encapsulate the enriched Bio-Gen Solution discharge. The MADE's may also be constructed of element tubing having many types of industrial coatings such as, but not limited to: Teflon, krylon, epoxies, Diamond Crystal, Polytetrafluoroethylene (PTFE), etc., such that the coating application would further enhance the controlled Meticulous Adhesion Disparity of the interior element tubing's Bio-Gen Solution passage way and would also be conducive in biological treatment of very viscous fluids with solid suspended particulate.

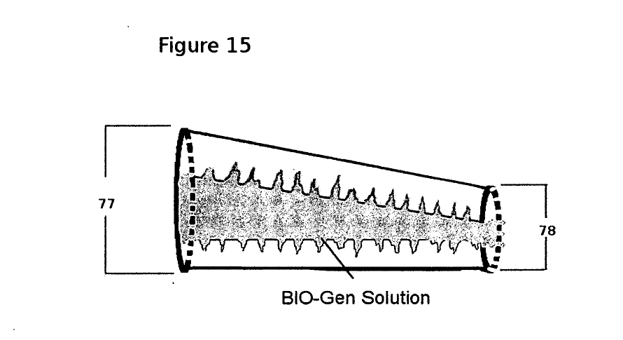

Referring to (FIG. 15) the MADE's design may also incorporate a modified mechanical means of meticulous adhesion disparity whereby the influent end of the tubing is larger (77) in diameter having greater surface area than that of the downstream diameter (78) (approximately 50% of the length) creating a conical cone of compression, mechanically amplifying the multi packing of the gaseous molecules in relation to surface disparity, therefore the balance of the length of the tubing being parallel having a controlled meticulous adhesion disparity would be conducive to biological treatment, chemical treatment, UV treatment in viscous fluids with a centipoise value of one or much greater than ten thousand. This design could also include the process of modified industrial coatings having controlled meticulous adhesion disparity and be conducive in the multi packing of gaseous molecules without cavitation of the nuclei therefore the carrier fluid enriched gas can be mixed with a bio-reactor or treatment area at atmospheric pressure. This Nano Gaseous invention provides a conducive process to allow viscous fluids of waste water with high nutrient content, water with high content of hydrocarbon oils, fuels, including crude to be processed with a admixture of multiple or a singular gaseous elements to create a dense molecular packing of the gaseous element in solution under pressure by means of a controlled meticulous adhesion disparity. This process will allow and support biological remediation of contaminates. This process could also allow for the use of UV to create an O₃ radical with a positive ion to destroy the stellar cell wall of contaminates.

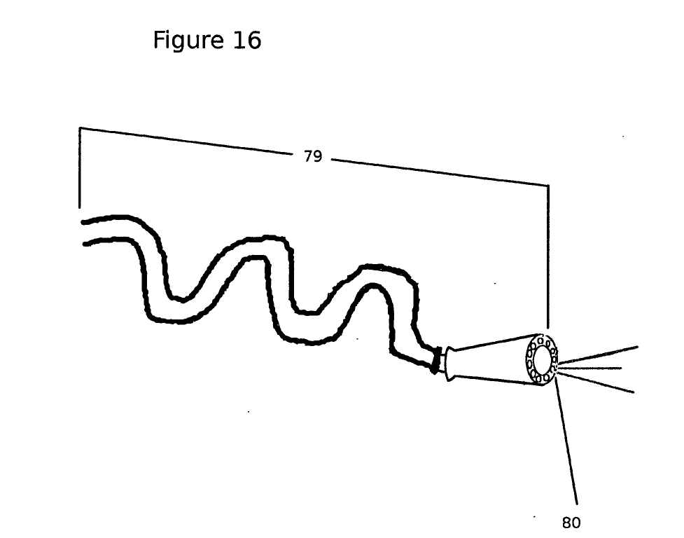

Referring to (FIG. 16) an alternative embodiment is provided herein whereby the MADE (79) is comprised of one or more single and/or multi-mode fiber optics (80) irradiating an enhanced Bio-Gen Solution at wavelength of ≦400 nm creating a plurality of radicals Whereas the dense molecular packing of a Gaseous Element consisting of Oxygen and/or Carbon Dioxide within the Liquid Element perennially cycling through the Nano Gaseous Equipment creates covalent molecular bonding of the Gaseous Element to the Liquid Element resulting in molecular weight reduction and density displacement of the Liquid Element by 40% or greater in volume therefore creating a mechanism of catalytic exchange and hydrogenation reactions having a much lighter Bio-Gen-Solution of gaseous enrichment conducive for electron promotion and ion-exchange while allowing for finer separation of total suspended solids (TSS) to drop out or become buoyant, forming a truly dissolved gaseous solution without cavitation of the nuclei and without formation of a bubbles so that the resultant discharge back into an atmospheric treatment reactor, waste stream, body of water or lake is a an ionized plurality of Bio-Gen Solution, such that if the Gaseous Element is oxygen saturating the Liquid Element the resultant effect is O₂, O₃, O₄, O₅, O₆, O₇, O₈, and/or O₉, bonded within the Liquid Element creates a Bio-Gen Solution that is irradiated at a wavelength of ≦400 nm creating a plurality of ionized radicals with a positive ion capable of destroying the stellar cell wall of contaminates.

The supersaturation of Ionized-Bio-Gen solution can be further enhanced, whereas dense molecular gaseous packing of a Gaseous Element creating a Bio-Gen Solution perennially cycling through the Gaseous Equipment MADE obtains a resultant denser multi-cell gaseous molecule, such that if the Gaseous Element is oxygen the resultant effect is O₂, O₃, O₄, O₅, O₆, O₇, O₈, and/or O₉, such that when contacting the PDSE the resultant effect creates numerous ionized SuperOxide O₂ and O₃ and OH radicals, so that the resultant discharge back into an atmospheric treatment reactor, waste stream, body of water or lake is a Enhanced Ionized-Bio-Gen Solution. Whereas the Enhanced Ionized-Bio-Gen solution is a truly dissolved ionized gaseous element with no cavitation of the nuclei and no formation of a bubbles, thus creating an supersaturated Enhanced Ionized-Bio-Gen solution having self-cleaning, self-sanitizing, self-deodorizing capabilities and a Ionized-Bio-Gen solution capable of the dissolution, decomposition and destruction of harmful contaminants, biological, chemical and electrochemical threats.

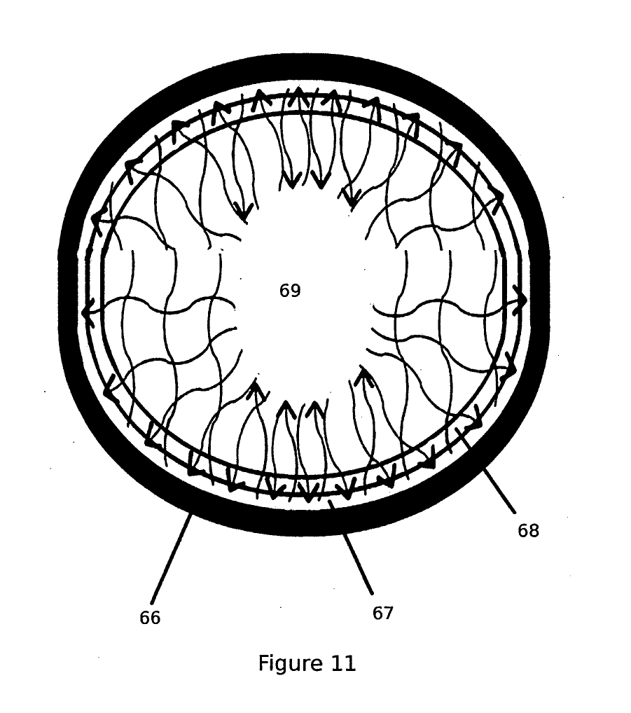

An alternative embodiment is provided whereby the inner walls of the MCFCR are mechanically smooth, buffed, or polished and afterwards coated by an OPB, ISB, or OISB coating by spin or dip coating to prevent surface degradation and to provide a smooth specular finish along the walls of the MCFCR to increase reflectance of UV emitting from the UV source to the PDSE to optimize the photocatalytic response of the PDSE and to maximize the generation of ionized radicals within the 50% of gaseous head of the Gaseous Element and/or within the 50% volume of the enriched carrier fluid/Liquid Element. Another alternative embodiment is provided referring to FIG. 11, a sectional over-head-view of an MCFCR, whereby the inner walls of the MCFCR 66 are lined with a Biaxially Oriented Polyethylene Terephthalate sheet film 67 to provide a smooth specular surface within the MCFCR, and afterwards coated by an OPB, ISB, or OISB coating 68 by spin or dip coating to prevent surface degradation of the Biaxially Oriented Polyethylene Terephthalate sheet film and to maintain the smooth specular finish along the walls of the MCFCR to increase reflectance of UV emitting 69 from the UV source to the PDSE to optimize the photocatalytic response of the PDSE and to maximize the generation of ionized radicals within the 50% of gaseous head of the Gaseous Element and/or within the 50% volume of the enriched carrier fluid/Liquid Element.

An alternative embodiment is provided herein whereby the Nano Gaseous equipment is comprised of one or more Molecular Continuous Flow Cell Reactor/s (MCFCR/s) containing one or more PDSE's/electrolyte located within the 50% head of Gaseous Element and within the 50% volume of Carrier Fluid/Liquid element functioning as an alternative duel phase power generation source to operate the Nano Gaseous equipment, making it suitable for applications in remote locations where power is an issue. Whereas the dense molecular packing of a Gaseous Element within the Liquid Element perennially cycling through the Nano Gaseous Equipment creates covalent molecular bonding of the Gaseous Element to the Liquid Element resulting in molecular weight reduction and density displacement of the Liquid Element by 40% or greater in volume therefore creating a mechanism of catalytic exchange and hydrogenation reactions having a much lighter Bio-Gen-Solution of gaseous enrichment conducive for electron promotion and ion-exchange while allowing for finer separation of total suspended solids (TSS) to drop out or become buoyant. The Gaseous Element may consist of Oxygen, Hydrogen, Carbon Dioxide, Nitrogen, Argon and/or Helium or combinations thereof. Such that if the Gaseous Element is oxygen O₂ saturating the Liquid Element the resultant effect is O₂, O₃, O₄, O₅, O₆, O₇, O₈, and/or O₉, bonded within the Liquid Element causing enhanced bacterium microbe consumption to hyper-accelerate bacterium microbe digestion and remediation of contaminates resulting in the generation of energy via the microbes passing electrons generating heat that may be transferred to an auxiliary storage battery used to power the Nano Gaseous Equipment or the energy maybe used to power the Nano Gaseous Equipment directly. A suitable battery manufacturer is EnerSys Corporation USA.

Phase two energy generation occurs when the photon (UV) energy is greater than or equal to the band gap energy of the PDSE's/electrolyte (i.e., E=3.2 eV or lambda (λ) ≦400 nm) within the MCFCR/s, more specifically located within the 50% head Gaseous Element and within the 50% volume of Carrier Fluid/Liquid Element. The irradiation of UV at a predetermined wavelength contacting the PDSE/s induces photocatalytic reactions within the PDSE/s causing electrons e− to be promoted from the valence band into the conduction band and the electrochemical oxidation of the oxygen ions with hydrogen or carbon monoxide within the 50% head of Gaseous Element and within the 50% volume of Carrier Fluid/Liquid Element. Thus creating within the 50% head Gaseous Element an induced reactively charged semi-plasma from the Gaseous Element and atomized Carrier Fluid Solution from the MCFPI and thus creating within the 50% volume of Carrier Fluid/Liquid Element an induced reactively charged transmission medium of gaseous enriched Bio-Gen Solution having less density. Such that the photocatalytic promotion of electrons from the PDSE/s cause the formation of charged SuperOxide O₂⁻, O₃⁺, and the formation of OH⁻ radicals capable of liberating hydrogen from hydrogen carrying substances and causing the dissolution of contaminates, thus allowing ionized oxygen to combine with hydrogen to provide a charge that may be transferred to an auxiliary storage battery used to power the Nano Gaseous Equipment or the energy maybe used to power the Nano Gaseous Equipment directly making the process self-regenerative. Under these conditions, both the rate and the orders of reaction vary with the sequence of addition of the reactants. Some of the electrons which have been excited into the conduction band and some of the holes in the valence band will recombine and dissipate the input energy as heat, thus leaving a resultant by-product of CO₂ and H₂O. The PDSE/s within the MCFCR/s operate at low temperature and does not require high temperatures to generate ionized oxygen O₂ radicals, also the PDSE photocatalytic reactions are not subject to reaction poisoning.

### Ancillary Monitoring and Control Devices

The ancillary monitoring and control devices would consist of but not limited to a ORP (Oxygen Reduction Potential) meter Conductivity meter H₂S (Hydrogen Sulfide) meter dissolved oxygen meter with a LDO probe or membrane unit with a controller that reads the probe signal and interpolates the signal thru the controller with a output signal that could be in millivolts, milliamps, voltage and processed to the Nano Gaseous Equipment PLC (Programmable Logic Controller) as a input value to open and close the zone valves to maintain and control the treatment area gaseous solution to a desired saturation level. The controller value could read as milligrams per litre, parts per million, or a negative or positive voltage reading. The PLC would be preferably be programmed with a high value (reset) and a low value (set) for each of the zone valves to be controlled individually. This would allow for greater gaseous saturation control in one or more treatment areas being treated simultaneously.

Although there has been illustrated and described specific detail and structure of operations, it is clearly understood that changes and modifications may be readily made therein by those skilled in the art without departing from the spirit and the scope of this invention.

What we claim is:

1. Nano Gaseous Equipment apparatus and method for creating dense nano molecular packing of a gaseous element/s in solution exposed to one or more Photocatalytic Dielectric Semiconducting Element/s (PDSE/s) inducing self-regenerative photocatalytic reactions without cavitation of nuclei and without bubbles, for the dissolution, destruction, disinfection, remediation and chemical oxidation of biological, chemical, electrochemical threats and contaminants in treatment applications, said apparatus and method comprises:
(a) a method that provides an effective means to treat viscous fluids of wastewater having high nutrient content, having high content of hydrocarbons, oils, fuels, crude, bacterial threats, pharmaceuticals, chemicals, electrochemicals . . . etc., with a admixture of multiple or singular Gaseous Element/s including but not limited to oxygen (O), hydrogen (H), helium (He), nitrogen (N), carbon dioxide (CO2), and/or argon (Ar) or in combinations thereof;
(b) comprised of one or more Molecular Continuous Flow Cell Reactor/s (MCFCR/s) that infuses both Gaseous Elements and Liquid Elements;
(c) comprised of one or more Photocatalytic Dielectric Semiconducting Element/s (PDSE/s) position within the MCFCR having self-cleaning, self-sanitizing, self-deodorizing, self-regenerative properties to create strong SuperOxide O₂ and OH and O₃ radicals to destruct the stellar cell wall of harmful bacteria, and destruct chemical, biological, and electrochemical threats;
(d) controlled by a PLC (programmable logic controller) and a HMI (human machine interface) that allows programming thru the HMI to all the gaseous equipment including pumps, carrier fluid valves/zone valves, gaseous valves, control of the concentration levels of Gaseous Elements introduced to the treatment area and all ancillary pumps, gaseous measurement meters, LMI metering pump, or peristaltic pump, accessory filtration;
(e) gaseous element/s being supplied via high pressure cylinder, a high pressure liquid gas cylinder, or by an on-site high pressure gaseous generator;
(f) gaseous source is inter-connected by a high pressure chemically inert hose, or ridged piping to a influent gaseous connector;
(g) connector is rigidly piped to a high pressure regulator that controls the Nano Gaseous Equipment input pressure and can be set between 15 psi (=1.03 bar) and 400 psi (=31.02 bar) giving greater control to the concentration and saturation of the carrier fluid;
(h) a regulator is piped to a back flow preventer/check valve to prevent any back pressure from damaging the regulator;
(i) the back flow preventer/check valve is piped to an electric solenoid valve/ball valve that is controlled by the PLC to allow and maintain a consistent gaseous positive pressure in the MCFCR/s;
(j) a solenoid valve is piped to the MCFCR with a tee that allows for a mechanical blow off valve set at 450 psi maximum pressure;
(k) PLC monitors all pressures and has first option in the logic to control any over pressure and in the event of component failure. The mechanical blow off valve is a way to exhaust any over pressure in a controlled release;
(l) liquid element is liquid carrier fluid pumped from the treatment area by a field supply pump as a suction centrifugal or a submersible thru a hose with a gallons per minute greater than the design intake of the equipment;
(m) the supply pump hose is attached to the influent liquid connector and is hard piped to a degasifier;
(n) the degasifier is a process to trap and bleed off a coarse bubble prior to the hard piping from the degasifier to a positive displacement pump;
(o) the degasifier component is based on 25 percent of the gallon per minute positive displacement pump;
(p) the degasifier component is fabricated from pipe tubing with a diameter and length relative to the positive displacement pump volume;
(q) the pipe tubing then has a welded cap affixed to the top end with a half inch pipe thread port to allow an air-trol to bleed off any gaseous element trapped in the top of the degasifier component, and the bottom end has a welded cap with a 2 inch pipe plug that allows for a 1.5 inch float switch to be located inside the degasifier chamber and wired along with a pressure switch;
(r) The degasifier configuration is volumetrically full and under necessary pressure to supply carrier fluid to the system without cavitation or dry pump damage;
(s) the degasifier has a influent port and a effluent port;
(t) the degasifier's influent port is two times the size of the positive displacement pump supply port and is located 8 inches off the bottom to ensure any buoyant gaseous coarse bubbles entering the degasifier are transferred out of the mainstream of carrier fluid and vented from an air-trol;
(u) the degasifier's effluent port is located at the bottom, below the influent port to ensure all carrier fluid has been degassed and that there is a continuous flow of liquid carrier fluid;
(v) the positive displacement pump takes 60 psi influent pressure up to the operating pressure of the MCFCR pressure;
(w) the positive displacement pump is hard piped to a check valve preventing any back pressure in to the positive displacement pump;
(x) the check valve is hard piped to a Molecular Carrier Fluid Poppet Injector (MCFPI);
(y) the MCFPI spray is collective in the bottom 50% of the MCFCR and monitored by a differential pressure transducer with a high pressure port hard piped to the bottom of the MCFCR in the liquid carrier fluid portion and the low pressure hard piped to the gaseous portion of the MCFCR;
(z) the pressure transducer measures the gaseous pressure against the bottom port pressure and the weight of the water column creating a differential pressure signal to the PLC and is interpolated into a variable positive displacement pump speed to control and maintain a positive carrier fluid level;
(aa) the lower portion of the MCFCR has a carrier fluid effluent port located approximately 6 inches off the bottom of the flow cell that is hard piped to a carrier fluid header with multiple porting to allow for a singular or multiple valving that are controlled by the PLC;
(bb) the valving train is known as zone valves that enables the PLC to control the enriched carrier fluids direction to single or to multiple treatment areas;
(cc) the zone valves are connected by zone tubing that can be ridged pipe or of a poly material such as PEX flexible tubing that is directed from the Nano Gaseous Equipment to one or more treatment areas;
(dd) one end of the zone tubing is connected to a zone valve with the opposing end connected to one or more mechanically affixed Meticulous Adhesion Disparity Elements (MADE/s) to enable delivery of an enriched carrier fluid (Liquid Element/Bio Gen Solution) without cavitation of the nuclei and without forming a bubble to the treatment area;

2. The MCFCR as recited in claim 1, are constructed of a material or combination of materials that are suitable for a pressure environment, and that will remain stable so as not to degrade and/or react to the gaseous elements or carrier fluid/liquid elements, such materials may include but are not limited to composite materials, composite fiber materials, metal alloys, metals and/or combinations thereof, preferable the MCFCR is constructed of stainless steel one piece welded construction.

3. The MCFCR as recited in claim 2, is of a specially engineered design having a vertical orientation with a height and diameter relative to the flow-rate in gallons-per-minute (gpm) of the liquid element to maintain a reaction equilibrium with the gaseous element, such that a 50% percent free head of gaseous element and 50% percent of liquid element occupy the total volume capacity of the MCFCR to maintain equilibrium within the MCFCR, and maximize the carrier fluid contact time, which results in higher levels of gaseous carrier fluid:
(a) such that if the gaseous equipment is a 15 gpm unit, the MCFCR would have a volume of 30 gallons;
(b) such that if the gaseous equipment is a 20 gpm unit, the MCFCR would have a volume of 40 gallons;
(c) such that if the gaseous equipment is a 30 gpm unit, the MCFCR would have a volume of 60 gallons;
(d) such that if the gaseous equipment is a 40 gpm unit, the MCFCR would have a volume of 80 gallons;
(e) such that if the gaseous equipment is a 50 gpm unit, the MCFCR would have a volume of 100 gallons;
(f) such that if the gaseous equipment is a 100 gpm unit, the MCFCR would have a volume of 200 gallons, . . . etc.;
(g) so that within the MCFCR a reaction equilibrium of a 50% percent free head of gaseous element and a 50% percent volume of liquid element is maintained.

4. The Nano Gaseous Equipment as recited in claim 1, may be comprised of two MCFCR's, such that if the gaseous equipment is a 50 gpm unit, the Gaseous Equipment may incorporate a co-dependent design having two MCFCR's, with each MCFCR receiving 25 gpm of liquid element, thus each co-dependent MCFCR would have a total volume of 50 gpm in order to maintain equilibrium between the Gaseous Element and the Liquid Element with each occupying 50% percent of the volume of each co-dependent MCFCR to make up 100%.
(a) the co-dependent MCFCR's are connected by an intake Gaseous and Liquid equilibrium module so that the intake of both the Gaseous Element and the Liquid Element and conditions of the co-dependent MCFCR's are identical.

5. The MCFCR as recited in claim 1, mounted to the upper most portion of the MCFCR's welded cap is a specially designed conical shaped Molecular Carrier Fluid Poppet Injector (MCFPI) that is secured by means of pipe thread to allow for a positive seal and easy removal if maintenance is needed.

6. The MCFPI as recited in claims 1 and 5, incorporates the design features of being affixed top-dead-center to the upper most top of the MCFCR gaseous flow cell.

7. The MCFPI as recited in claim 6, has an orientation parallel to the side walls of the MCFCR having an equal distance from the side walls of the MCFCR all the way around so that the MCFPI is centered.

8. The MCFPI as recited in claim 6, is comprised of a stainless steel 90 degree compression fitting with 1 inch pipe thread on the opposing end and has a three quarter inch tube 4 inches long welded to the threaded end;
(a) the 4 inch length tube has an internal crimped radius at a half inch from the bottom that allows for a threaded stem with a circular flared end to seat against;
(b) the stem fits inside of the tubing with a spring, loaded with approximately 1 pound of tension;
(c) the tension allows for the stem to open with resistance against the variable carrier fluid flow that creates a conical micro fine spray pattern thru the gaseous element creating greater enrichment of the carrier fluid, and allows for greater variables in flow rates maintaining a micro fine conical spray pattern.

9. The MCFPI as recited in claim 8, could be made in larger diameters or used in multiples for larger flow rates of 5000 gallons per minute or more.

10. The MCFPI as recited in claim 8, has a specially designed spring loaded injector core that allows it to compensate and work at variable flow rates and pressures to maintain a very fine conical atomization spray pattern whether the flow rate fluctuates from 1 gpm to 50 gpm, so that the spray pattern remains at a constant, and is continuous.

11. The MCFPI as recited in claim 10, spring loaded injector core allows for viscous wastewater carrier fluids having micro particulates and/or solid elements to pass thru the MCFPI without blinding the injector while maintaining a constant and continuous spray pattern.

12. The MCFCR as recited in claim 3, containing the MCFPI may be constructed in varying sizes, but it is preferably that the diameter of the MCFCR is 36 inches or less, so that the carrier fluid distributed from the MCFPI has extended contact time with the 50% percent free head of gaseous element in order to maximize saturation of the carrier fluid with the Gaseous Element, thus forming the Liquid Element;
(a) the design and methodology allows for the MCFPI's injector to distribute a conical downward vertical fine atomized spray pattern that is parallel to the flow cell walls, so as not to contact the walls of the MCFCR and not to impede the interaction, and/or reactions of the carrier fluid saturation with the Gaseous Element;
(b) the desired distance of descent of the carrier fluid distributed from the MCFPI through Gaseous Element to the Liquid Element is not less than 1½ ft. (feet), but it is preferred that the distance is 2 ft. or more to maximize the carrier fluid contact time with the Gaseous Element;
(c) the MCFCR and MCFPI provides a more efficient method for infusing a Gaseous Element into a Carrier Fluid/Liquid Element at a high gallons-per-minute (gpm) rate without blinding or clogging and effectively replaces the need to use a plurality of MCFPI's;
(d) the function and methodology of the MCFCR and MCFPI is designed to create a longer spray pattern with greater surface area and contact time with the gaseous element resulting in greater efficiencies and greater concentration levels of Liquid Element.

13. As recited in claim 1, the MCFCR may be comprised of one or more Photocatalytic Dielectric Semiconducting Elements (PDSE/s) within the MCFCR that reacts with the Gaseous Element and the Liquid Element within the MCFCR to from strong ionized radicals having self-cleaning, self-sanitizing, self-deodorizing and self-regenerative properties, capable of the dissolution, decomposing and destruction of biological, chemical and electrochemical threats:
(a) The PDSE/s may be positioned in various locations within the MCFCR to optimize the photocatalytic response of the PDSE and to maximize generation of ionized radicals within the 50% of gaseous head of the Gaseous Element and within the 50% volume of the enriched carrier fluid now referred to Liquid Element.

14. As recited in claims 1 and 13, the PDSE utilizes a thin dielectric film placed on a substrate to achieve photocatalytic reactions within the MCFCR with high UV absorbance, reflectance and/or high photopic transmittance;
(a) the reaction forms strong SuperOxide O₂ and O₃ and OH radicals (disruptors);
(b) capable of destroying microbial viruses such as but not limited to salmonella (Salmonellosis), e-coli (Escherichia Coli) and listeria (Listeriosis);
(c) and capable of the dissolution, decomposition and destruction harmful contaminants, biological, chemical and electrochemical threats;
(d) leaving a resultant by-product of CO₂ and H₂O, because the potential energy of the radicals generated by the PDSE is greater than the bonding energy of the harmful contaminants, biological, chemical and electrochemical threats.

15. As recited in claim 14, sources of UV within the MCFCR may include but are not limited to sunlight, single and/or multi-mode fiber, light emitting diode (LED), fluorescent lamps, mercury lamps, gas-discharge lamps . . . etc. that may be positioned in various locations within the MCFCR to optimize the photocatalytic response of the PDSE, and to maximize generation of ionized radicals within the 50% of gaseous head of the Gaseous Element and/or within the 50% volume of the enriched carrier fluid now referred to as the Liquid Element.

16. As recited in claim 13, one or more PDSE/s are positioned within the 50% of gaseous head of the Gaseous Element and 50% of the Liquid Element, such that a Gaseous Element contacting the PDSE and the deposition of the atomized carrier fluid from the MCFPI contacting the PDSE create ionized SuperOxide O₂ and O₃ and OH radicals thus enriching the Liquid Element with ionized radicals;
(a) the infusion process of ionized gaseous element and liquid is known as a coarse ionized gaseous enriched carrier fluid/Liquid element that collectively forms in the bottom 50% of the MCFCR, whereas the one minute stabilization period allows for a consistent concentration of the coarse ionized gaseous enriched carrier fluid;
(b) the coarse ionized gaseous enriched carrier fluid is then directionally piped to one or more zone valves then piped as coarse ionized gaseous enriched Liquid Element to the Meticulous Adhesion Disparity Element/s (MADE/s);
(c) whereas the MADE/s creates multi-dense packing of the ionized SuperOxide O₂, OH and O₃ radicals and creates molecular bonding of the ionized radicals to the liquid and discharges a Ionized Bio-Gen solution;
(d) the Ionized-Bio-Gen solution is a truly dissolved ionized gaseous element with no cavitation of the nuclei and with no formation of a bubbles;
(e) is a supersaturated Ionized-Bio-Gen solution having self-cleaning, self-sanitizing, self-deodorizing capabilities and a Ionized-Bio-Gen solution capable of the dissolution, decomposition and destruction of harmful contaminants, biological, chemical and electrochemical threats.

17. The PDSE as recited in claims 1, 13, 14, 15, and 16, within the MCFCR comprises a substrate upon which a number of alternating dielectric films are deposited;
(a) the substrate can be transmissive for all wavelengths of light or non-transmissive to wavelengths of light, but in both cases the dielectric film is highly reactive to wavelengths of light within a predetermined spectrum and is otherwise transmissive;
(b) the PDSE can be an optically clear multilayered hard durable thin film comprised of an external contact layer of photocatalytic semiconducting titanium dioxide (TiO₂);
(c) the TiO₂ may be partially composed of its brookite, rutile, and/or anatase phase, but preferable the TiO₂ is in the anatase phase having photocatalytic properties that reacts to greater than 90% of all UV with a series of tailored thin film dielectric layers designed with narrow contoured spectral bandwidths to react to UV within a predetermined spectrum;
(d) the UV output source can come from a sunlight, light emitting diode (LED), fluorescent lamps, mercury lamps, gas-discharge lamps . . . etc.,
(e) the UV is then reflected back to the external contact layers of the PDSE producing a concentration of UV at the external surface of the PDSE, thus initiating self-regenerative photocatalytic reactions of titanium dioxide (TiO₂);
(f) when the photon energy is greater than or equal to the band gap energy of TiO₂, i.e., E=3.2 eV or lambda (λ) ≦400 nm, an electron, e− is promoted from the valence band into the conduction band, leaving a hole behind;
(g) some of the electrons which have been excited into the conduction band and some of the holes in the valence band recombine and dissipate the input energy as heat;
(h) a number of holes diffuse to the surface of the TiO₂ and react with the Gaseous Element and the Carrier Fluid/Liquid Element within the MCFCR forming OH absorbed on the surface;
(i) the reaction forms SuperOxide O₂, OH radicals and O₃ radicals that are capable of the dissolution, decomposition and destruction of harmful biological, chemical and electrochemical contaminants, thus leaving a resultant by-product of CO₂ and H₂O greatly because the potential energy of the OH radical is greater than the bonding energy of almost all contaminates;
(j) the substrate material may be composed of but not limited to metals, metal alloys, composites, glass, plastics and materials such as Polytetrafluoroethylene (PTFE), Polyethylene Terephthalate (PET), Polyethylene Terephtalate Glycol-modified (PETG) or combination thereof.

1. The PDSE the thin dielectric layers recited in claim 17:
(a) a plurality of dielectric layers comprised of alternating layers of a first dielectric material and a second dielectric material, each layer having a high index of refraction, deposited upon the substrate for reflecting UV within a predetermined spectrum and otherwise transmitting light wherein the index of refraction of both the first dielectric material and the second dielectric material are different from each other, and each is greater than 2.0; and
(b) a photocatalytic coating of TiO₂ disposed on the dielectric layer opposite the substrate designed to induce photocatalytic reactions in the presence of UV to provide a self-cleaning, self-sanitizing, and self-deodorizing combiner surface.

19. The PDSE as recited in claims 17 and 18, wherein the first dielectric material is selected from a group including tantalum oxide (Ta₂O₅) and zirconium oxide (ZrO₂) and the second dielectric material is photocatalytic titanium oxide TiO₂

20. The PDSE as recited in claims 17 and 18, wherein both the first dielectric material and the second dielectric material are comprised of the same material, which may be deposited by electron beam physical vapor deposition, reactive ion plating deposition, ion assisted deposition and/or evaporative coating deposition;
(a) the first dielectric material being deposited by means of reactive ion plating, the second dielectric material being deposited by evaporative coating.

20. The PDSE as recited in claim 20, wherein both the first and second dielectric materials are photocatalytic titanium oxide TiO₂ having indices of refraction greater than 2.0

21. The PDSE as recited in claim 20, further comprising:
(a) a decorative reflective layer,
(b) deposited upon a hard organic leveling polymer which has been placed onto a layer of the combiner by one of the methods of dip coating or spin coating
(c) wherein the decorative reflective layer is in one of either a pure form, oxide form, nitride form or oxynitride form, and is selected from the materials including deposition chromium (Cr), silver (Ag), gold (Au), platinum (Pt), aluminum (Al), titanium (Ti), or zirconium (Zr), nickel (Ni), tin (Sn)

22. The PDSE as recited in claim 20, further comprising a decorative reflective layer deposited onto a layer of the PDSE stack and a hard organic leveling polymer onto the decorative reflective layer by one of the methods of either dip coating or spin coating, wherein the decorative reflective layer is in one of either a pure form, oxide form, nitride form or oxynitride form, and is selected from the materials including deposition chromium (Cr), silver (Ag), gold (Au), platinum (Pt), aluminum (Al), titanium (Ti), or zirconium (Zr), nickel (Ni), tin (Sn).

23. The PDSE as recited in claim 18, further comprising a decorative reflective layer deposited upon a hard organic leveling polymer which has been placed onto a layer of the PDSE by one of the methods of dip coating or spin coating wherein the decorative reflective layer is in one of either a pure form, oxide form, nitride form or oxynitride form, and is selected from the materials including deposition chromium (Cr), silver (Ag), gold (Au), platinum (Pt), aluminum (Al), titanium (Ti), or zirconium (Zr), nickel (Ni), tin (Sn).

24. The photocatalytic dielectric combiner as recited in claim 18, wherein both the first dielectric material and the second dielectric material are comprised of the same material, the first dielectric material being deposited by means of reactive ion plating, the second dielectric material being deposited by another method.

25. The PDSE sub stage concentrator, comprising:
(a) a PDSE having a transmissive dielectric cover transmissive to all wavelengths of light for transmitting light there-through;
(b) a plurality of dielectric layers for reflecting a predetermined spectrum of light comprised of a first and a second dielectric material which are the same, reflect 98% of UV, and are transmissive to all other light and wherein the first and second dielectric materials have an index of refraction greater than 2.0 and
(c) wherein the plurality of dielectric layers concentrates and reflects UV back through the surface of the transmissive dielectric cover.

26. The PDSE as recited in claim 25, wherein the first and second dielectric materials are photocatalytic titanium oxide (TiO.sub.2) and the material of the transmissive dielectric cover is silicon dioxide (SiO.sub.2).

27. The PDSE as recited in claim 25, wherein both the first dielectric material and the second dielectric material are comprised of photocatalytic titanium oxide (TiO.sub.2), with the first material being deposited by means of reactive ion plating and the second dielectric material being deposited by means of evaporative coating.

28. Photocatalytic titanium dioxide (TiO₂) film is placed on the PDSE substrate by a Sol-Gel Method;
(a) comprised of one or more layers of photoreactive gelatin which have be subsequently developed by wet chemical processing;
(b) in which a substrate is dipped into a titanium alkoxide solution, TPT monomer or polymer chelated with glycol polymer;
(c) whereas the substrate is pulled out, and the rate in which the substrate is pulled out determines the coating thickness;
(d) the coated substrate is then heated at about 600 degrees ° C. to form the crystalline anatase phase.

29. as recited in claim 1, the Nano Gaseous Equipment is comprised of a Meticulous Adhesion Disparity Element (MADE) consisting of one or more tubular element/s having a controlled surface disparity along the inner channel and inner walls of the tubular element/s to create an interior roughness to modify and enhance the friction of the Liquid Element passing thru its length causing it to become greater;
(a) whereas the meticulous adhesion disparity creates multi-dense packing of the Gaseous Element thus creating covalent molecular bonding of the Gaseous Element to the Liquid Element, so that the resultant discharge back into an atmospheric treatment reactor, waste stream, body of water or lake is a Bio-Gen Solution;
(b) whereas this Bio-Gen Solution is a truly dissolved Gaseous Element with no cavitation of the nuclei and no formation of a bubbles, therefore being relative in size to molecular organisms and capable to effectively and efficiently support microbial growth and chemical treatment;
(c) Whereas the dense molecular gaseous packing of a Gaseous Element such as oxygen (O₂) in a Bio-Gen Solution perennially cycling through the Nano Gaseous Equipment and MADE obtains a resultant dense multi-cell oxygen molecule consisting of O₂, O₃, O₄, O₅, O₆, O₇, O₈, and/or O₉.
(d) Whereas dense molecular gaseous packing of a Gaseous Element such as carbon dioxide (CO₂) in a Bio-Gen Solution perennially cycling through the Gaseous Equipment and MADE obtains a resultant dense multi-cell molecule consisting of CO₂, CO₃, CO₄, CO₅, CO₆, CO₇, CO₈, or CO₉;
(e) The Gaseous Element/s may consist of Oxygen, Hydrogen, Carbon Dioxide, Nitrogen, Argon and/or Helium or combinations thereof.

30. The MADE recited in claim 29, element's tubing could also include multiple mechanical S-bends stacked to approximately 6 to 8 inches apart to allow for greater surface adhesion disparity for longer tubing to be packaged in a modular shorter space for treatment of heavy viscous fluids.

31. The MADE recited in claim 29, may be constructed of a material or combination of materials that are suitable for a pressure environment, and that will remain stable and have little to no degradation and/or have little to no reaction to the Gaseous Elements nor to the Liquid Elements:
(a) such materials may include but are not limited to composite materials, composites, composite fiber materials, glass, metals, metals alloys, plastics and materials such as Polytetrafluoroethylene (PTFE), polypropylene, silicone, and/or combinations thereof;
(b) the suitable material would be chemically inert to the Gaseous and Liquid Elements traveling through the tubular channels of the MADE/s element/s having a surface that is modifiable to achieve the right amount of controlled meticulous adhesion disparity surface tension within the elements tubular channels;
(c) to create a dense molecular packing of the Gaseous and Liquid Elements as such the Gaseous and Liquid Elements become molecularity bonded to prevent any cavitation of the nuclei;
(d) therefore there is no formation of a buoyant gaseous bubble.

32. As recited in claim 31, the MADE, and its tubular element channels are constructed of stainless steel:
(a) the manufacturing process of the tubular element/s could be formed from a flat sheet or a strip roll of suitable material that would have the finish surface modified to a specific surface roughness by means of using several different methods used for surface modification;
(b) including but not limited to, Deep Reactive-Ion Etching (DRIE), photochemical etching, industrial etching methods, wet etching, acid etching, sanding, grinding, or other methods of modified surface finishes;
(c) the material then would be sheared, cut, and trimmed to a width equal to the circumference of the desired internal finish diameter by means of mechanical roll forming, stamping, or other tubular forming processes;
(d) the tubular material would then be processed thru a micro fusion process applicable to the materials adhesion either by micro welding, a bonding adhesive, or thermo fusion of the linear cold joint equal to the structural integrity embodiment material;
(e) the diameter of the MADE's tubular element/s may consist of varying diameters having a maximum diameter of up to 2″ inches, preferably the MADE's tubular element/s have a diameter ranging from 1000 microns (=1 millimeter=0.0393 inches) to diameter of 6350 microns (=0.250 inches).
(f) the length of the element tubing comprising the MADE is determined by the viscosity of the solution, size and volume of solid suspended particulate and the controlled surface disparity to the interior wall of the passage way;
(g) the MADE's design and method of meticulous adhesion disparity is well suited in treatment applications for solutions having a viscous centipoise value of >1.0 or greater and for wastewater solutions having suspended solids and/or particulates so as to create multi-dense molecular packing of Gaseous Element/s to create covalent molecular bonding to Liquid Element/s without cavitation of the nuclei and without formation of a bubbles
(h) the MADE's design and method of meticulous adhesion disparity allows for use of much larger diameters to prevent clogging and blinding of its tubular elements;

33. The MADE's design and method of meticulous adhesion disparity is well suited in treatment applications for solutions such as bio-remediation of municipal waste, which has a matrix of viscous fluid, suspended solids, micro fibers, industrial chemical and organic pollutants.

34. The MADE's design and method of meticulous adhesion disparity is well suited in treatment applications such as hydrocarbon emulsification and remediation of viscous crude, processed lubricants, fuels, glycols, and other forms of manufactured products derived from crude are very and conducive to this treatment process.

35. The MADE's design and method of meticulous adhesion disparity is well suited in treatment applications such as chemical oxidation treatment of arsenic and of fluids having a viscosity with a centipoise (cP) value of ≧1 or greater.

36. The MADE's design and method of meticulous adhesion disparity is well suited in treatment applications such as agricultural manure management of nutrient loading to enable the biological remediation process to treat phosphorous, ammonia, nitrite, nitrates, hydrogen sulfide and consume the nutrient loading rendering greater quality of waste water.

37. The MADE's design and method of meticulous adhesion disparity is well suited for desalination treatment applications:
(a) whereby sea water enriched with high concentrations of calcium become crystallized calcium by the infusion of multi-dense molecular packing of carbon dioxide gas;
(b) forming a calcium-bicarbonate crystal that can be then filtered out rendering a solution that could be disinfected using the PDSE;
(c) thus creating potable water meeting standards for human consumption.

38. The MADE recited in claims 30 and 31, configuration channel could be straight with a length of one foot to ten feet or could have multiple stacked S bends having a length of twenty feet to create greater mechanical meticulous adhesion disparity.

39. The MADE recited in claim 29, is comprised of multiple element tubing's affixed to a tubular header manifold having sufficient spacing between each of the element tubing's comprising the MADE to allow for dilution water to fully encapsulate the enriched Bio-Gen Solution discharge:
(a) the MADE's may also be constructed of element tubing having many types of industrial coatings such as, but not limited to; Teflon, krylon, epoxies, Diamond Crystal, Polytetrafluoroethylene (PTFE), etc.;
(b) such that the coating application would further enhance the controlled Meticulous Adhesion Disparity of the interior element tubing's Bio-Gen Solution passage way and would also be conducive in biological treatment of very viscous fluids with solid suspended particulate;
(c) the MADE's design may also incorporate a modified mechanical means of meticulous adhesion disparity whereby the influent end of the tubing is larger in diameter having greater surface area than that of the downstream diameter, approximately 50% of the length;
(d) creating a conical cone of compression, mechanically amplifying the multi packing of the gaseous molecules in relation to surface disparity, therefore the balance of the length of the tubing being parallel having a controlled meticulous adhesion disparity would be conducive to biological treatment, chemical treatment, UV treatment in viscous fluids with a centipoise value of one or much greater than ten thousand;
(e) This design could also include the process of modified industrial coatings having controlled meticulous adhesion disparity and be conducive in the multi packing of gaseous molecules without cavitation of the nuclei therefore the carrier fluid enriched gas can be mixed with a bio-reactor or treatment area at atmospheric pressure;
(f) which provides a conducive process to allow viscous fluids of waste water with high nutrient content, and water with high content of hydrocarbon oils, fuels, including crude to be processed with a admixture of multiple or a singular gaseous elements to create a dense molecular packing of the gaseous element in solution under pressure by means of a controlled meticulous adhesion disparity;

40. the MADE recited in claim 29, may be comprised of one or more single and/or multi-mode fiber optics irradiating an enhanced Bio-Gen Solution at wavelength of ≦400 nm creating a plurality of radicals;
(a) dense molecular packing of a Gaseous Element consisting of Oxygen and/or Carbon Dioxide within the Liquid Element that is perennially cycling through the Nano Gaseous Equipment creates covalent molecular bonding of the Gaseous Element to the Liquid Element;
(b) resulting in molecular weight reduction and density displacement of the Liquid Element by 40% or greater in volume
(c) therefore creating a mechanism of catalytic exchange and hydrogenation reactions having a much lighter Bio-Gen-Solution of gaseous enrichment conducive for electron promotion and ion-exchange
(d) while allowing for finer separation of total suspended solids (TSS) to drop out or become buoyant, forming a truly dissolved gaseous solution without cavitation of the nuclei and without formation of a bubbles;
(e) the resultant discharge back into an atmospheric treatment reactor, waste stream, body of water or lake is a an ionized plurality of Bio-Gen Solution;
(f) that if the Gaseous Element is oxygen saturating the Liquid Element the resultant effect is O₂, O₃, O₄, O₅, O₆, O₇, O₈, and/or O₉, bonded within the Liquid Element creates a Bio-Gen Solution that is irradiated at a wavelength of ≦400 nm creating a plurality of ionized radicals with a positive ion capable of destroying the stellar cell wall of contaminates;
(g) the super-saturation of Ionized-Bio-Gen solution can be further enhanced, when dense molecular gaseous packing of a Gaseous Element creating a Bio-Gen Solution is perennially cycling through the Nano Gaseous Equipment and MADE and it obtains a resultant denser multi-cell gaseous molecule;
(h) such that if the Gaseous Element is oxygen the resultant effect is O₂, O₃, O₄, O₅, O₆, O₇, O₈, and/or O₉, when contacting PDSE/s the resultant effect creates numerous ionized SuperOxide O₂ and O₃ and OH radicals;
(i) so that the resultant discharge back into an atmospheric treatment reactor, waste stream, body of water or lake is an Enhanced Ionized-Bio-Gen Solution.
(j) such that the Enhanced Ionized-Bio-Gen solution is a truly dissolved ionized gaseous element with no cavitation of the nuclei and no formation of a bubbles;
(k) having self-cleaning, self-sanitizing, self-deodorizing capabilities and a Ionized-Bio-Gen solution capable of the dissolution, decomposition and destruction of harmful contaminants, biological, chemical and electrochemical threats.

41. The inner walls of the MCFCR are mechanically smooth, buffed, or polished and afterwards coated by an OPB, ISB, or OISB coating by spin or dip coating:
(a) to prevent surface degradation and to provide a smooth specular finish along the walls of the MCFCR;
(b) to increase reflectance of UV emitting from the UV source to the PDSE;
(c) to optimize the photocatalytic response of the PDSE; and
(d) to maximize the generation of ionized radicals within the 50% of gaseous head of the Gaseous Element and within the 50% volume of the enriched carrier fluid/Liquid Element.

42. The inner walls of the MCFCR are lined with a Biaxially Oriented Polyethylene Terephthalate sheet film to provide a smooth specular surface within the MCFCR:
(a) and afterwards coated by an OPB, ISB, or OISB coating by spin or dip coating to prevent surface degradation of the Biaxially Oriented Polyethylene Terephthalate sheet film;
(b) to maintain the smooth specular finish along the walls of the MCFCR to increase reflectance of UV emitting from the UV source to the PDSE;
(c) to optimize the photocatalytic response of the PDSE; and
(d) to maximize the generation of ionized radicals within the 50% of gaseous head of the Gaseous Element and/or within the 50% volume of the enriched carrier fluid/Liquid Element.

43. The Nano Gaseous equipment is comprised of one or more Molecular Continuous Flow Cell Reactor/s (MCFCR/s) containing one or more PDSE's/electrolyte located within the 50% head of Gaseous Element and within the 50% volume of Carrier Fluid/Liquid element functioning as an alternative duel phase power generation source to operate the Nano Gaseous equipment;
(a) making it suitable for applications in remote locations where power is an issue;
(b) the dense molecular packing of a Gaseous Element within the Liquid Element is perennially cycling through the Nano Gaseous Equipment creates covalent molecular bonding of the Gaseous Element to the Liquid Element;
(c) resulting in molecular weight reduction and density displacement of the Liquid Element by 40% or greater in volume;
(d) creating a mechanism of catalytic exchange and hydrogenation reactions having a much lighter Bio-Gen-Solution of gaseous enrichment conducive for electron promotion and ion-exchange;
(e) the Gaseous Element may consist of Oxygen, Hydrogen, Carbon Dioxide, Nitrogen, Argon and/or Helium or combinations thereof.
(f) the Gaseous Element is oxygen O₂ saturating the Liquid Element the resultant effect is O₂, O₃, O₄, O₅, O₆, O₇, O₈, and/or O₉, bonded within the Liquid Element causing enhanced bacterium microbe consumption to hyper-accelerate bacterium microbe digestion resulting in the generation of energy via the microbes passing electrons generating heat;
(g) that may be transferred to an auxiliary storage battery used to power the Nano Gaseous Equipment or the energy maybe used to power the Nano Gaseous Equipment directly;
(h) energy generation also occurs when the photon (UV) energy is greater than or equal to the band gap energy of the PDSE's/electrolyte (i.e., E=3.2 eV or lambda (λ) ≦400 nm) within the MCFCR/s located within the 50% head Gaseous Element and within the 50% volume of Carrier Fluid/Liquid Element;
(i) the irradiation of UV at a predetermined wavelength contacting the PDSE/s induces photocatalytic reactions within the PDSE/s causing electrons e− to be promoted from the valence band into the conduction band and the electrochemical oxidation of the oxygen ions with hydrogen or carbon monoxide within the 50% head of Gaseous Element and within the 50% volume of Carrier Fluid/Liquid Element;
(j) creating within the 50% head Gaseous Element an induced reactively charged semi-plasma from the Gaseous Element and atomized Carrier Fluid Solution from the MCFPI;
(k) and also creating within the 50% volume of Carrier Fluid/Liquid Element an induced reactively charged transmission medium of gaseous enriched Bio-Gen Solution having less density;
(l) that the photocatalytic promotion of electrons from the PDSE/s cause the formation of charged SuperOxide O₂⁻,)₃⁺, and the formation of OH⁻ radicals capable of liberating hydrogen from hydrogen carrying substances and causing the dissolution of contaminates, thus allowing ionized oxygen to combine with hydrogen to provide a charge;
(m) that may be transferred to an auxiliary storage battery used to power the Nano Gaseous Equipment or the energy maybe used to power the Nano Gaseous Equipment directly making the process self-regenerative;
(n) the rate and the orders of reaction may vary with the sequence addition of reactants, some of the electrons which have been excited into the conduction band and some of the holes in the valence band will recombine and dissipate the input energy as heat;
(O) leaving a resultant by-product of CO₂ and H₂O;
(p) the PDSE/s within the MCFCR/s operate at low temperature and do not require high temperatures to generate ionized oxygen O₂ radicals;
(q) the PDSE photocatalytic reactions are not subject to reaction poisoning.
